(19) United States
(12) Patent Application Publication
(10) Pub. No.: US 2026/0177131 A1
(43) Pub. Date: Jun. 25, 2026

(54) SHIFT SYSTEM AND METHOD FOR POWER TRANSMISSION ASSEMBLY

(71) Applicant: Means Industries, Inc., Saginaw, MI (US)

(72) Inventor: Kyle N. Ball, Saginaw, MI (US)

(73) Assignee: Means Industries, Inc., Saginaw, MI (US)

(21) Appl. No.: 19/419,740

(22) Filed: Dec. 15, 2025

Related U.S. Application Data
(60) Provisional application No. 63/737,889, filed on Dec. 23, 2024.

(51) Int. Cl. F16H 3/089; F16H 3/10; F16H 3/12; F16H 63/04; F16H 63/24

(52) U.S. Cl. CPC F16H 3/089; F16H 3/10; F16H 3/12; F16H 63/04; F16H 63/24; F16H 2200/0034

(57) ABSTRACT

A system and method for power transmission system that includes a first shaft, a second shaft, a gear assembly between the first shaft and the second shaft. The gear assembly includes a first gear and a second gear. A first coupling mechanism selectively couples the first shaft and the second shaft through the first gear. A second coupling mechanism selectively couples the first shaft and the second shaft through the second gear wherein the second coupling mechanism includes a ratcheting locking element movable between a deployed and a nondeployed position.

### CROSS-REFERENCE TO RELATED APPLICATIONS

This application claims the benefit of U.S. Provisional Application No. 63/737,889, filed on Dec. 23, 2024. The disclosure of the above application is incorporated herein by reference.

### BACKGROUND OF THE INVENTION

### 1. Field of the Invention

The invention generally relates to a vehicle power train; and, more specifically, a power train using a shift system including a one-way clutch.

### 2. Description of Related Art

In the field of automotive technology, vehicle powertrains typically include shift systems using multiple friction clutch elements. Automatic transmissions (AT) use wet friction clutches, dual-clutch transmissions (DCT) use wet & dry friction clutches, and manual transmission (MT) and automated manual transmissions (AMT) use synchronizers, friction cone clutches, and a shift collar.

Other shift mechanisms use various elements of the above or in combination with a mechanical dog clutch, shift collar, or sliding sleeve.

Friction clutches add drag, reduce efficiency, and reduce electric vehicle range. They also create heat, wear, and contamination that can lead to other failure modes. Friction clutches require hydraulics, fluids, pumps, and hydraulic distribution. This adds weight, complexity, possibility of leaks and generates heat.

Elimination of friction clutches also addresses an industry need to support sustainability and circular economy objectives and targets. Friction clutches wear, need replacing, and cannot be reused, repurposed, or easily recycled. Additionally, friction clutch inefficiencies constitute a significant source of heat generation.

Battery electric vehicle drive systems include thermal management issues related to heat generation.

Existing powertrains often use electric motors and controllable or selectable coupling assemblies, such as one-way clutches. These coupling assemblies can be electromagnetically operated and magnetically controlled. Various types of selectable one-way clutches, including those using a selector plate, a solenoid, and a linear actuator, are known. The foregoing are examples of one-way clutches that may be used in the clutch system disclosed herein.

### SUMMARY OF THE INVENTION

A power transmission system that includes a first shaft, a second shaft, a gear assembly between the first shaft and the second shaft. The gear assembly includes a first gear and a second gear. A first coupling mechanism selectively couples the first shaft and the second shaft through the first gear. A second coupling mechanism selectively couples the first shaft and the second shaft through the second gear wherein the second coupling mechanism includes a ratcheting locking element movable between a deployed and a nondeployed position. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration and overview of a multi-speed transmission, including a shift system according to one example of the power transmission system of the present invention.

FIG. 2 is a schematic cross-sectional view illustrating one example of a shift system and mechanism for use with the power transmission system of FIG. 1, including an actuator in one position.

FIGS. 2A and 2B are cross-sectional views illustrating locking element positions for the actuator position of FIG. 2.

FIG. 3 is a schematic cross-sectional view illustrating one example of the shift system for use with the power transmission system of FIG. 1, including an actuator in another position.

FIGS. 3A and 3B are cross-sectional views illustrating locking element positions for the actuator position of FIG. 3.

FIG. 4 is a schematic cross-sectional view illustrating the shift system for use with the power transmission system of FIG. 1, including the actuator in yet another position.

FIGS. 4A and 4B are cross-sectional views illustrating locking element positions for the actuator position of FIG. 4.

FIG. 5 is a flowchart of an example of a method of operation of a shift system for a power transmission assembly of FIGS. 2-4.

FIG. 6 speed over time diagram according to the method of FIG. 5.

FIG. 7 is a flowchart of an example of another method of operation of a shift system for a power transmission assembly of FIGS. 2-4.

FIG. 8 speed over time diagram according to the method of FIG. 7.

FIG. 9 is a flowchart of an additional example of a method of operation of a shift system for a power transmission assembly of FIGS. 2-4.

FIG. 10 speed over time diagram according to the method of FIG. 9.

FIG. 11 is a flowchart of a further example of a method of operation of a shift system for a power transmission assembly of FIGS. 2-4.

FIG. 12 speed over time diagram according to the method of FIG. 11.

FIG. 13 is a schematic illustration and overview of a multi-speed transmission, including a planetary gear system and a shift system, according to another example of the power transmission system of the present invention.

FIG. 14 is a schematic cross-sectional view illustrating one example of a shift system and mechanism for use with the power transmission system of FIG. 13, including an actuator in one position.

FIGS. 14A and 14B are cross-sectional views illustrating locking element positions for the actuator position of FIG. 14

FIG. 15 is a schematic cross-sectional view illustrating one example of a shift system and mechanism for use with the power transmission system of FIG. 13, including an actuator in another position.

FIGS. 15A and 15B are cross-sectional views illustrating locking element positions for the actuator position of FIG. 15.

FIG. 16 is a flowchart of an example of a method of operation of a shift system for a power transmission assembly of FIGS. 13-15.

FIG. 17 speed over time diagram according to the method of FIG. 16.

FIG. 18 is a flowchart of an example of a method of operation of a shift system for a power transmission assembly of FIGS. 13-15.

FIG. 19 speed over time diagram according to the method of FIG. 18.

FIG. 20 is a flowchart of an example of a method of operation of a shift system for a power transmission assembly of FIGS. 13-15.

FIG. 21 speed over time diagram according to the method of FIG. 20.

FIG. 22 is a flowchart of an example of a method of operation of a shift system for a power transmission assembly of FIGS. 13-15.

FIG. 23 speed over time diagram according to the method of FIG. 22.

### DETAILED DESCRIPTION OF THE PREFERRED EMBODIMENTS

The following description of the preferred embodiment(s) is merely exemplary in nature and is in no way intended to limit the invention, its application, or its uses.

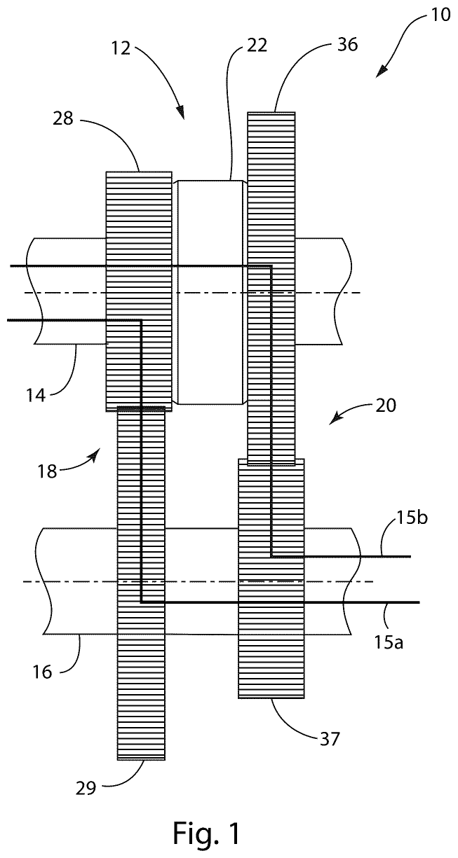

FIG. 1 schematically illustrates one example of a power transmission system or assembly 10, including a shift system 12. The power transmission system or assembly 10 functions as a torque-transmitting mechanism between respective components.

The power transmission system or assembly 10 includes a first or driving shaft 14 and a second or driven shaft 16. The first or driving shaft 14, also referred to as an input shaft, receives input from a power source, for example, an electric motor. The second or driven shaft 16, also referred to as an output shaft, provides an output from the power transmission system or assembly 10 to a driven member, for example, a drive component associated with one or more vehicle wheels. Both the first and second shafts 14, 16 rotate at variable rotation speeds. When used with a hybrid or electric vehicle in a regeneration mode, torque supplied from the second or driven shaft 16, from a vehicle wheel, acts through the power transmission system or assembly 10 to provide torque to the first or driving shaft 14 and ultimately to the motor.

In one example, the power transmission system or assembly 10 includes a 1^{st} gear assembly/ratio 18 and a 2^{nd} gear assembly/ratio 20. The 1^{st} gear assembly/ratio 18 includes gears 28, 29 between the first shaft 14 and the second shaft 16. The 2^{nd} gear assembly/ratio 20 includes gears 36, 37 between the first shaft 14 and the second shaft 16. The shift system 12 selectively couples the first shaft 14 and the second shaft 16 through either the 1^{st} gear assembly/ratio 18 or the 2^{nd} gear assembly/ratio 20. Selecting the different gear ratios changes the speed and torque. It provides two power or torque paths 15a, 15b, one through the 1^{st} gear assembly/ratio 18 and a second through the 2^{nd} gear assembly/ratio 20. In one example, the shift system 12 includes one-way clutches.

A one-way clutch produces a mechanical connection. A one-way clutch may be passive. A passive one-way or overrunning clutch always produces a drive connection or engaged state and transfers torque between components when their relative rotation is in one direction, overruns when relative rotation is in the opposite direction, and overruns when their relative rotation is in the same direction and the driven member rotates faster than the drive member. The passive one-way or overrunning clutch overruns when the drive or input member rotates slower than the driven or output member. The direction of driving and overrunning in the opposite direction depends upon the direction of rotation of the driving member.

One example of a passive one-way clutch or passive strut assembly includes a passive or uncontrolled locking element, for example, a strut, disposed in the pocket of a pocket plate. A resilient member or spring continuously biases the strut outward of the pocket in the pocket plate—the strut is continuously deployed. The one-way clutch is passive because the strut is not controlled. The strut is constantly biased outward of the pocket and past a side face or surface of the first coupling member or pocket plate. The resilient member or spring constantly urges the strut out of the pocket to a deployed position, wherein the strut extends out of the pocket in the first coupling member or pocket plate. In the outward position, the locking element engages the second coupling member, for example, engages a notch in a notch plate. The one-way clutch prevents rotation of the second coupling member or notch plate in one direction of rotation and allows overrun; that is, the second coupling member or notch plate rotates freely in the opposite direction. The one-way clutch passively controls torque in one direction and overruns in the opposite direction.

A one-way clutch may be a selectable or controllable one-way clutch; the state of the one-way clutch, activated or deactivated-deployed or nondeployed, can be selected or controlled. A selectable or controllable one-way clutch may also be referred to as an active one-way clutch. A selectable or controllable one-way clutch in a nondeployed condition allows overrun in both directions and may function like a passive one-way clutch when deployed. Hence, a selectable or controllable one-way clutch is active; the state of the locking element, deployed or nondeployed, can be controlled. A selectable or controllable one-way clutch may also be passive because the locking element, when deployed, can be overrun.

A selectable or controllable one-way clutch typically includes a control mechanism or actuator that activates or deactivates the one-way clutch to enable or disable a drive connection or engaged state between components. A selectable or controllable one-way clutch may include locking elements combined with an actuator and/or selector mechanism. The selector mechanism is operative to control the deployment of the locking element. When deployed the locking element selectively mechanically couples the associated components. For example, a selectable or controllable one-way clutch is active because the locking element in the pocket plate may move between a nondeployed position—the locking element in the pocket of the pocket plate and a deployed position—the locking element extending outwardly from the pocket of the pocket plate and beyond or past the face or side surface of the pocket plate. In the deployed position, the locking element engages the second coupling member or notch plate, wherein the one-way clutch passively locks in one direction of rotation and freely rotates or overruns in the opposite direction. The locking elements, actuator, and/or selector add multiple functions to the one-way clutch, including implementing the different operating modes. When deactivated, the active one-way clutch produces no drive connection or engaged state between the components and transfers no torque. When activated, the active one-way clutch produces a drive connection or engaged state, transfers torque between components when their relative rotation is in one direction, and overruns in the same manner as the passive one-way or overrunning clutch. An active one-way clutch may not engage and may operate passively when placed in an activated position. Even though the active one-way clutch is activated, depending on the relative movement of the components, it may not actively engage and will not produce a drive connection or engaged state. However, because it is in an activated position, it engages and transfers torque based on the relative movement of the components.

A dynamically controllable clutch refers to a controllable or selectable, active one-way clutch acting between two rotating components, for example, one where both races are rotatable. An overrunning dynamically controllable clutch refers to a controllable or selectable active one-way clutch acting between two rotating components; for example, one where both races are rotatable and capable of overrunning when deployed.

The power transmission system or assembly 10 provides a shift technology meeting vehicle performance needs, for example, smooth shifting and improved hybrid or electric vehicle efficiency and range. In one example, the power transmission system or assembly 10 provides a mechanical locking element shift system, including a passive one-way clutch and an active one-way clutch. Using the one-way clutches as an upshift and downshift transition aid provides for less complex control strategies. Less complex controls equal less development cost and fewer potential failure modes.

The power transmission system or assembly 10 is notably suitable for use with an electric vehicle or electric motor. The system or assembly 10 takes advantage of the precise control and efficiency of a variable-speed motor, including the ability to change or vary motor speed in a short period. For example, an electric motor typically used for electric vehicles may transition from 1500 rpm to 2000 rpm in milliseconds. While the power transmission system or assembly 10, including the shift system 12, takes advantage of electric motor operating parameters, it is not limited to use with an electric motor.

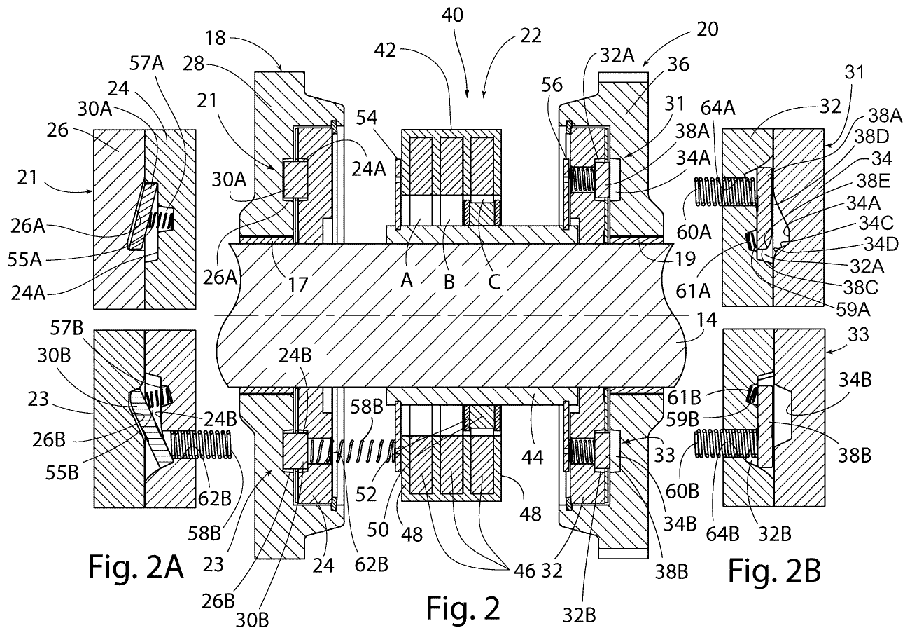

FIGS. 2-4B schematically illustrate one example of the shift system 12 using a coupling mechanism, generally seen at 22, positioned between the 1^{st} gear assembly/ratio 18 (1^{st} gear node) and the 2^{nd} gear assembly/ratio 20 (2^{nd} gear node). The coupling mechanism 22 includes a passive one-way clutch or coupling assembly 21 and a first controllable one-way clutch or coupling assembly 23, both operative to connect the first shaft 14 to the second shaft 16 at the 1^{st} gear assembly/ratio 18. The coupling mechanism 22 further includes a second and third controllable one-way clutch or coupling assembly 31, 33 operative to connect the first shaft 14 to the second shaft 16 at the 2^{nd} gear assembly/ratio 20. Gear ratios represent the gears' relation to each other in size. When different-sized gears mesh, they can spin at different speeds and deliver different amounts of torque and speed. For example, engaging 1^{st} gear delivers low speed but high torque.

The 1^{st} gear assembly/ratio 18 includes two rotating races, i.e., a first coupling member in the form of a pocket plate 24 and a second coupling member in the form of a notch plate 26. The pocket plate 24 is fixedly connected to the first shaft 14 of the power transmission system or assembly 10, and the notch plate 26 forms part of or is fixedly connected to a gear 28 of the 1^{st} gear assembly/ratio 18. The gear 28 is rotatably supported by a bearing 17 on the first shaft 14 for relative rotation on the shaft 14.

The pocket plate 24 contains first and second sets of locking elements 30A, 30B for clockwise (“CW”) and counterclockwise (“CCW”) engagement, respectively. During engagement, at least one set of the locking elements 30A, 30B contact the pocket and notch engagement faces of the pocket and notch plates 24, 26, connecting the pocket and notch plates 24, 26 together. The pocket and notch plates 24, 26 connect the first shaft 14 and the gear 28 of the 1^{st} gear assembly/ratio 18. The locking elements 30A, 30B transmit torque between the first shaft 14 and the gear 28, which are connected via the connected pocket and notch plates 24, 26.

Similar to the 1^{st} gear assembly/ratio 18, the 2^{nd} gear assembly/ratio 20 also includes two rotating races, i.e., a first coupling member in the form of a pocket plate 32 and a second coupling member in the form of a notch plate 34. The pocket plate 32 is fixedly connected to the first shaft 14 of the power transmission system or assembly 10. The notch plate 34 forms part of or is fixedly connected to a gear 36 of the 2^{nd} gear assembly/ratio 20. The gear 36 rotatably supported on the first shaft 14 by a bearing 19 for relative rotation on the shaft 14.

The pocket plate 32 contains first and second sets of locking elements 38A, 38B for clockwise (“CW”) and counterclockwise (“CCW”) engagement, respectively. During engagement, at least one of the sets of locking elements 38A, 38B contacts the pocket and notch engagement faces of the pocket and notch plates 32, 34, connecting the pocket and notch plates 32, 34 together. The pocket and notch plates 32, 34 connect the first shaft 14 and the gear 36 of the 2^{nd} gear assembly/ratio 20. The locking elements 38A, 38B transmit torque between the first shaft 14 and the gear 36, which are connected via the connected pocket and notch plates 32, 34.

In one example, the locking elements 30B, 38A are locking elements that “ratchet” or operate in a “ratchet” state and may be referred to as ratcheting locking elements. As used herein, ratchet or ratcheting means the relative rotational motion or rotational speed between the locking element and corresponding notch plate is at a high enough magnitude such that the locking element is unable to or cannot move deep enough into a notch to engage and stop relative rotational motion between the pocket plate and the notch plate. The relative rotational motion between the locking element, being at least partially contained in the pocket plate, and the notch plate, containing notches with which the locking element can engage, is in a direction that would generally allow the locking element to protrude into the notch, engage with it, and stop relative rotational motion in that direction. Instead of engaging a notch, the locking element skips out of the notch, allowing continued relative motion. “Ratcheting” can also be used to describe a clutch or locking element associated with a ratchet state. For example, the clutch is ratcheting, the locking element is ratcheting, or it is a ratcheting locking element. Different locking element or pocket configurations, shapes, or designs enable a locking element to “ratchet.” For example, a structure or configuration of the locking element, the notch of the notch plate, and/or a combination thereof of the coupling assembly keeps a deployed locking element from engaging the notch plate until reaching a predetermined window of rotational speed. Above a predetermined window of rotational speed the locking element ratchets, does not protrude into the notch, engage with the notch, and stop relative rotational motion in the direction of engagement. Below or within the predetermined window of rotational speed the locking element engages a notch of notch plate to stop or prevent relative rotation between pocket plate and notch plate in the direction of engagement.

FIG. 2 is one example of a structure or configuration of the locking element and/or a notch of the notch plate of the coupling assembly or mechanism that keeps a deployed locking element from engaging until reaching a predetermined window of rotational speed. The locking element 38A includes an engagement end 38C and an upper face 38D defining a ramped surface 38E. In one example, locking element 38A ramped surface 38E has a convex shape and, in another example has an ellipsoid shape. The ramped surface 38E is operative to urge the locking element 38A towards a position of non-abutting engagement of the locking element 38A with the notch plate 34 when the relative rotational speed in the same direction of rotation, the direction of engagement, is above a predetermined window of rotational speed, wherein the locking element 38A ratchets. The engagement end 38C of the locking element 38A does not engage a notch 34A of notch plate 34 and stop or prevent relative rotation between pocket plate and notch plate in the same direction of rotation, the direction of engagement, above the predetermined window of rotational speed.

FIG. 2 shows one example of a notch 34A having a ramped surface 34D positioned adjacent to the load-bearing shoulder 34C. In one example, the ramped surface 34D has a convex shape and, in another example has an ellipsoid shape. The ramped surface 34D of each of the notch operative to urge each locking element 38A toward the position shown in FIG. 2B. More specifically, the ramped surfaces 34D, 38E form camming surfaces that operate to urge each locking element 38A from protruding, tipping, or dropping into the notch 34A, wherein the locking element 38A ratchets. The engagement end 38C of the locking element 38A does not engage the load-bearing shoulder 34C of the notch 34A of notch plate 34 and stop or prevent relative rotation between the pocket plate and notch plate in the same direction of rotation, the direction of engagement, above the predetermined window of rotational speed.

Examples of locking elements that “ratchet,” are set forth in U.S. Pat. Nos. 8,844,693, and 11,793,801. The entire disclosures of which are specifically incorporated herein by reference.

In one example, the coupling mechanism 22 includes an actuator in the form of a linear motor or linear actuator, generally seen at 40. The actuator 40 may be a three-position actuator, with the stator 42 having three induction coils 46.

The actuator 40 includes a stator 42 and a translator 44. For example, the stator 42 is fixed in position to a housing (not shown). The stator 42 includes induction coils 46 housed between steel plates 48.

The translator 44 includes an annular ring of segmented permanent magnets 50 and steel plates 52. The translator 44 connects to and rotates with the first shaft 14 and moves linearly between lateral, axial positions. The linear actuator 40 actively controls an operating mode of the shift system 12 by generating an electromagnetic force with the stator 42 that interacts with the translator 44, causing the translator to slide, move back and forth, axially on the first shaft 14.

The actuator 40 includes a first radially extending actuation or spring plate 54 associated with the 1^{st} gear assembly/ratio 18 and a second radially extending actuation or spring plate 56 associated with the 2^{nd} gear assembly/ratio 20. The first spring plate 54 acts on an actuation member, shown as a spring 58B, and the second spring plate 56 acts on actuation members, shown as springs 60A, 60B. In the disclosed example, the first spring plate 54 is associated with the first controllable one-way clutch or coupling assembly 23, and the second spring plate 56 is associated with the second and third controllable one-way clutches or coupling assemblies 31, 33 wherein axial movement of translator 44 correspondingly moves the spring plates 54, 56. The spring plate 54 applies a force to the spring 58B, wherein the spring 58B acts on locking element 30B. The spring plate 56 applies a force to the springs 60A, 60B, wherein the springs 60A, 60B act on the respective locking elements 38A, 38B. In one example, the springs 58B, 60A, 60B are coiled springs received within the respective passageways 62B, 64A, 64B to provide an actuating force to move the locking elements 30B, 38A, 38B between their engaged, deployed, and disengaged, nondeployed positions. Other actuators or actuation members besides springs may provide the actuating forces. Also, pressurized fluid may provide the actuating forces. In addition to a linear actuator, a cam actuator or a linear member with a shift fork may move the spring plates 54, 56 and the corresponding springs 58B, 60A, 60B. In the present example, the three-position actuator 40 does not act on the locking element 30A. The locking element 30A is passive, not actively controlled. A bias member or spring 55A in a blind bore 57A continuously acts on the locking element 30A to bias it out of the pocket 24A of the pocket plate 24 to an engaged or deployed position.

Each pocket 24B, 32A, 32B has an inner recess or blind bore 57B, 59A, 59B for receiving biasing members or springs 55B, 61A, 61B. The biasing members or springs 55B, 61A, 61B are located under the respective locking elements 30B, 38A, 38B and continuously act on the respective locking elements 30B, 38A, 38B to bias, or urge them outward to a deployed position. When the translator 44 moves to reposition the locking elements 30B, 38A, 38B to a nondeployed position, the actuation members or springs 58B, 60A, 60B exert a force on the locking elements 30B, 38A, 38B, overcoming the force of the biasing members or springs 55B, 61A, 61B, and moving the locking elements 30B, 38A, 38B inward to their nondeployed positions. The actuation members or springs 58B, 60A, 60B create a force, causing the locking elements 30B, 38A, 38B to pitch downward to a nondeployed position.

The shift system 12 includes the passive clutch or coupling assembly 21 associated with the 1^{st} gear assembly/ratio 18, a first controllable one-way clutch or coupling assembly 23 associated with the 1^{st} gear assembly/ratio 18, and second and third controllable one-way clutches or coupling assemblies 31, 33 associated with the 2^{nd} gear assembly/ratio 20. The passive clutch or coupling assembly 21 includes the locking element 30A. The locking element 30A transmits torque from the first shaft 14 to the gear 28 in the clockwise direction. The first controllable one-way clutch or coupling assembly 23 includes the locking element 30B. The locking element 30B transmits torque from the first shaft 14 to the gear 28 in the counterclockwise direction. The second controllable one-way clutch or coupling assembly 31 includes the locking elements 38A, and the third controllable one-way clutch or coupling assembly 33 includes the locking elements 38B. The locking element 38A transmits torque from the first shaft 14 to the gear 36 in the clockwise direction. The locking element 38B transmits torque from the first shaft 14 to the gear 36 in the counterclockwise direction. As used herein, the clockwise rotation of the first shaft 14 is associated with forward torque or forward vehicle motion, and the counterclockwise rotation of the first shaft 14 is associated with reverse torque, both reverse vehicle motion and forward regeneration torque.

The locking elements 30A, 30B of the passive clutch or coupling assembly 21 and the first controllable one-way clutch or coupling assembly 23 are separate one-way clutch locking elements.

The passive one-way clutch or coupling assembly 21 includes a passive or uncontrolled locking element, for example, the locking element 30A, in a pocket 24A of the pocket plate 24. The locking element 30A and pocket plate 24 associated with the passive one-way clutch are mounted on the first shaft 14, wherein the locking element 30A in the pocket 24A of the pocket plate 24 rotates with the first shaft 14. Because the locking element 30A is passive, the locking element 30A is continuously biased out of the pocket 32A, toward the engaged or deployed position and remains so regardless of the position of the translator 44. The locking element 30A associated with the passive one-way clutch or coupling assembly 21 is passive because the locking element 30A is not controlled. Depending on the direction and speed of rotation of the components, the locking element 30A of the passive one-way clutch or coupling assembly 21 either engages or overruns. In one direction, it engages, and in the other, it overruns. It also overruns when their relative rotation is in the same direction, and the driven member, for example, the notch plate 26, rotates faster than the drive member, the pocket plate 24. In an overrun condition the components may turn freely in at least one direction with respect to one another.

The first controllable one-way clutch or coupling assembly 23 includes a controlled locking element, for example, the locking element 30B. The actuator 40 moves the locking element 30B in the pocket 24B of the pocket plate 24 of the first controllable one-way clutch or coupling assembly 23 to a disengaged or nondeployed position. The locking element 30B is in the pocket 24 in an engaged or deployed position and the locking element 30B extends out of the pocket 24B in the engaged or deployed position. The locking element 30B engages a notch 26B in the notch plate 26 of the first controllable one-way clutch or coupling assembly 23.

The locking element 30A, coupled with the pocket plate 24 and notch plate 26, operates as a passive one-way clutch. The passive one-way clutch or coupling assembly 21 is used for 1^{st} gear torque. As the first shaft 14 rotates clockwise, the locking element 30A engages, coupling the gear 28 to the first shaft 14 in the clockwise direction and correspondingly rotates the gear 28 clockwise, imparting motion to the second shaft 16. The first controllable one-way clutch or coupling assembly 23 includes the locking element 30B. The locking element 30A of the passive one-way clutch or coupling assembly 21 transmits torque through the 1^{st} gear assembly/ratio 18 in a forward direction. The locking element 30B of the first controlled one-way clutch or coupling assembly 23 transmits reverse torque and regenerative torque through the first gear assembly/ratio 18.

The second and third controllable one-way clutches or coupling assemblies 31, 33 have respective controlled locking elements 38A, 38B. For example, the second controllable one-way clutch or coupling assembly 31 includes locking element 38A, and the third controllable one-way clutch or coupling assembly 33 includes the other locking element 38B. Both controllable one-way clutches or coupling assemblies 31, 33 operate similarly. For example, the actuator 40 moves one or both of the locking members 38A, 38B in the pockets 32A, 32B of the pocket plate 32 of the second and third controllable one-way clutches or coupling assemblies 31, 33 between an engaged or deployed position, wherein the locking element 38A, 38B extends out of its respective pocket 32A, 32B and a disengaged or nondeployed position, wherein the locking member 38A, 38B is in its respective pocket 32A, 32B. In the engaged or deployed position, the locking element 38A, 38B engages a corresponding notch 34A, 34B in the notch plate 34 of the second controllable one-way clutch or coupling assembly 31. The actuator 40 controls the movement of the locking members 38A, 38B of the second and third controllable one-way clutches or coupling assemblies 31, 33 between a deployed, engaged, or locked position and a nondeployed, disengaged, or unlocked position.

The second and third controllable one-way clutches or coupling assemblies 31, 33 are associated with 2^{nd} gear torque. As the first shaft 14 rotates clockwise, the locking element 38A engages, coupling the gear 36 to the first shaft 14 in the clockwise direction and correspondingly rotates the gear 36 clockwise, imparting motion to the second shaft 16. As the first shaft 14 rotates counterclockwise, the locking element 38B engages, coupling the gear 36 to the first shaft 14 in the counterclockwise direction and correspondingly rotates the gear 36 counterclockwise, imparting motion to the second shaft 16. The second and third controllable one-way clutches or coupling assemblies 31, 33 transmit forward, reverse, and regenerative torque. Forward torque results from rotating the first shaft 14 in the clockwise direction, with the corresponding gear 36 also rotated in the clockwise direction. Reverse torque results from rotating the first shaft 14 in the opposite or counterclockwise direction, with the corresponding gear 36 also rotated in the counterclockwise direction.

The actuator 40 is a three-position actuator that moves between three positions, represented by the letters A, B, and C, and acts on the first, second, and third controllable one-way clutches or coupling assemblies 23, 31, 33. Depending on the selected position, the locking elements 30B, 38A, 38B of the controllable one-way clutches of the first, second, and third controllable one-way clutches or coupling assemblies 23, 31, 33 are engaged/deployed or disengaged/nondeployed. The locking element 30A of the passive one-way clutch or coupling assembly 21 is always in an engaged/deployed position.

As shown in FIGS. 2, 2A, and 2B with the actuator 40 in the third position—Position C, associated with the far-right set of induction coils 46 of the actuator 40, the locking element 30A of the passive one-way clutch or coupling assembly 21 is engaged/deployed and transmits torque in the first or clockwise direction to the gear 28. The locking element 30B of the first controllable one-way clutch or coupling assembly 23 is also engaged/deployed and transmits torque in the counterclockwise direction to the gear 28. The locking elements 38A, 38B of the controllable one-way clutches of the second controllable one-way clutches or coupling assemblies 31, 33 are disengaged/nondeployed and transmit no torque in either direction to the gear 36, the gear 36 freewheels on the first shaft 14. In the third position—Position C, torque is transferred for forward propulsion, regenerative braking, and 1^{st} gear reverse.

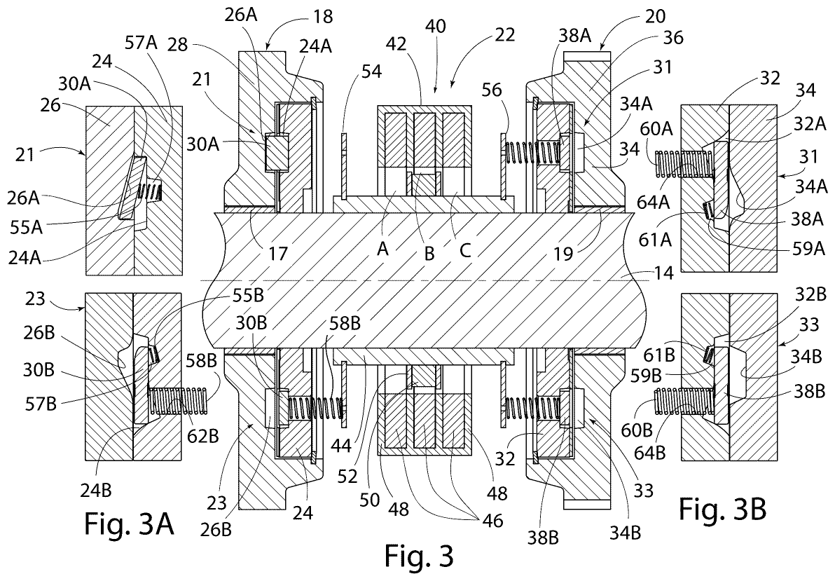

As shown in FIGS. 3, 3A, and 3B, with the actuator 40 in the second position—Position B, associated with the second or middle set of induction coils 46 of the actuator 40, the passive one-way clutch or coupling assembly 21 remains deployed, wherein the locking element 30A remains engaged/deployed and can, depending upon motor and first shaft 14 speed engage the notch 26A on the notch plate 26 and transmit torque in the clockwise or forward direction. The locking element 30B of the first controllable one-way clutch coupling assembly 23 moves to a disengaged/nondeployed position and remains in the pocket 24B of the pocket plate 24, wherein no torque is transferred in the counterclockwise direction. The locking element 30A of the passive one-way clutch or coupling assembly 21 remains in an overrun state. Depending upon the relative rotational speed of the components, in the second position, the passive one-way clutch or coupling assembly 21 transmits torque in one direction and overruns in the opposite; for example, if the gear 28 is rotating in the clockwise direction faster than the rotational speed of the first shaft 14. In the second position, the locking elements 38A, 38B of the second controllable one-way clutch or coupling assembly 31, 33 remain disengaged/nondeployed, wherein the gear 36 freewheels with respect to the first shaft 14.

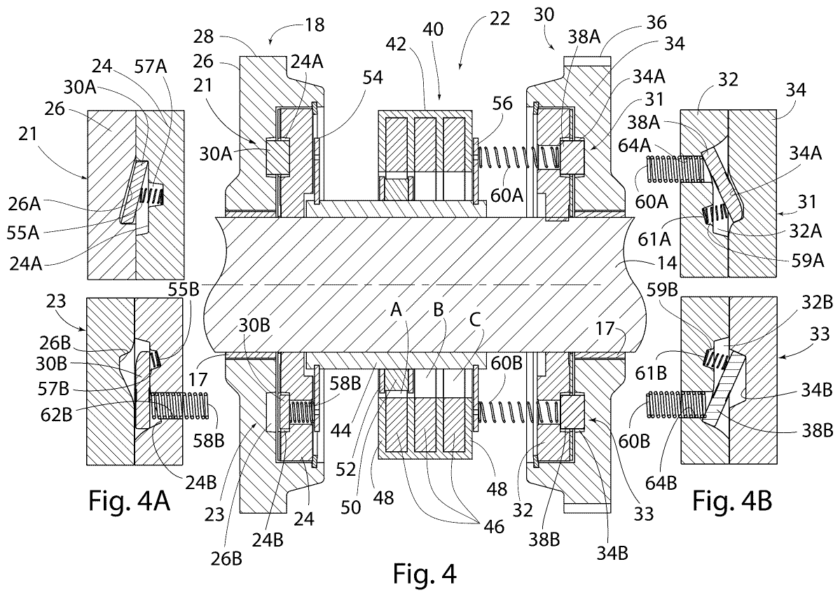

As shown in FIGS. 4, 4A, and 4B, with the actuator 40 in the first position—Position A, associated with the far-left set of induction coils 46 of the linear actuator 40, In the first position—Position A, the locking elements 38A, 38B of the controllable one-way clutches of the second and third controllable one-way clutch or coupling assembly 31, 33 are engaged/deployed and extend out of their respective pockets 32A, 32B in the pocket plate 32 and engage corresponding notches 34A, 34B in the notch plate 34 thereby coupling the gear 36 to the first shaft 14. In the first position, the second and third controllable one-way clutches or coupling assemblies 31, 33 transfer torque in both the forward and reverse directions for both forward propulsion, regenerative braking, and, if needed or desired, 2^{nd} gear reverse propulsion. In the first position, the locking element 30A of the passive one-way clutch or coupling assembly 21 is still biased out of pocket 24A of pocket 24; however, it is in a constant overrun condition. The gear 29 on the second shaft 16 rotates the gear 28 at a higher speed than the speed of the first shaft 14. As long as the locking element 38A of the second controllable one-way or coupling assembly 31 is engaged, the gear 28 will always overrun the locking element 30A of the passive one-way clutch or coupling assembly 21. The locking element 30B of the first controllable one-way clutch or assembly 23 is in the disengaged/nondeployed position and transmits no torque.

The 1^{st} gear assembly/ratio 18 uses the passive one-way clutch or coupling assembly 21 to transmit 1^{st} gear forward torque, and the first controllable one-way clutch or coupling assembly 23 to transmit 1^{st} gear regenerative and reverse torque. The 2^{nd} gear assembly uses the second and third controllable one-way clutches or coupling assemblies 31, 33 to transmit 2^{nd} gear forward torque, regenerative torque, or reverse torque. When shifting to 2^{nd} gear, the first controllable one-way clutch or coupling assembly 23 is turned off; however, the passive one-way clutch or coupling assembly 21 remains on and still reacts to forward torque. The 2^{nd} gear shift is commanded and controlled by activating the second and third controllable one-way clutches or coupling assemblies 31, 33.

The actuator 40 shown in FIGS. 2-4B illustrates an example of a three-position actuator. The actuator 40 has three positions A, B, and C. In the following example, the actuator 40 uses only two of the positions, position A and position C. Position B can also be used to vary the modes. Position B may be a neutral position or some other mode. In one example, the actuator may be a multiple positions actuator having, for example, three, four, and five positions. Multiple position actuators provide multiple modes of engagement.

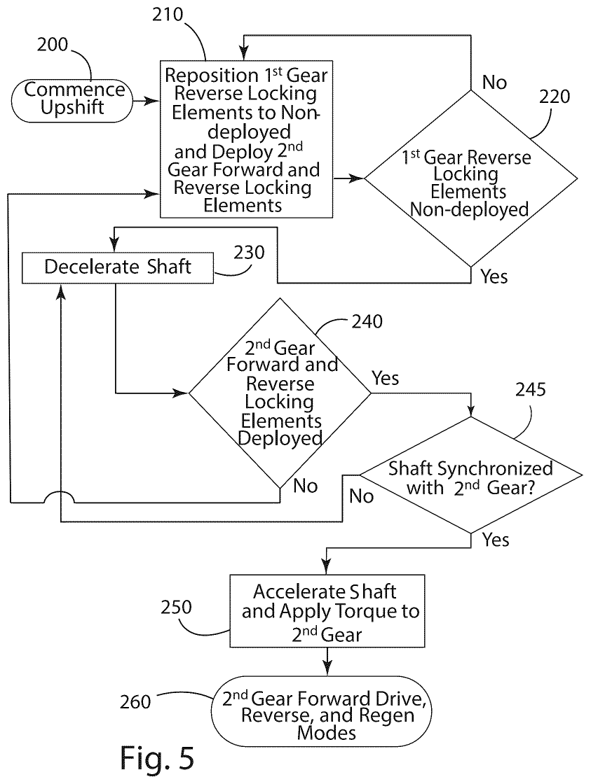

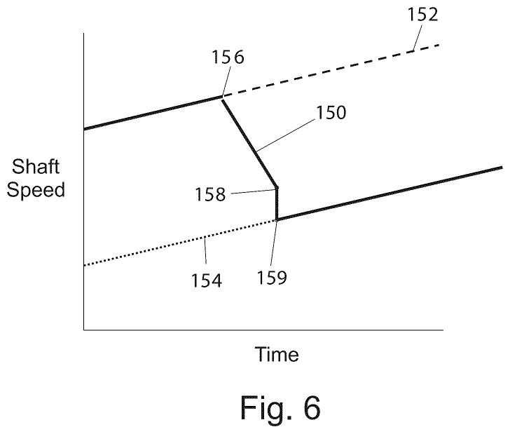

FIG. 5 is a flowchart of one example of the inventive system and method showing an upshift from 1^{st} gear to 2^{nd} gear, wherein the power transmission system or assembly 10 shifts from 1^{st} gear forward propulsive torque to 2^{nd} gear forward propulsive torque. FIG. 6 is a speed over time diagram illustrating relative shaft and gear speeds. The drawing schematically illustrates the speed, solid line 150, of the first shaft 14; the speed, dashed line 152, of the gear 28; and the speed, dotted line 154, of the gear 36.

FIG. 5 shows the method begins in step 200 with a signal or command to commence an upshift from 1^{st} gear forward to 2^{nd} gear forward. Initially, the actuator 40 is in the third position—Position C. The passive one-way clutch or coupling assembly 21, including the forward torque transmitting locking element 30A, and the controllable one-way clutch or coupling assembly 23, including the reverse torque transmitting locking element 30B, are deployed. Each extends outward from its respective pocket 24A, 24B of the pocket plate 24. The locking elements 30A, 30B transfer forward, reverse, and regenerative torque, respectively. The locking elements 38A, 38B of the second and third controllable one-way clutches or coupling assemblies 31, 33 are nondeployed. Each locking element 38A, 38B remains in its respective pocket 32A, 32B. The locking elements 38A, 38B transfer no torque from the first shaft 14 through the gear 36 to the second gear assembly/ratio 20. Because the locking element 30A is deployed, it passively couples the shaft 14 and gear 28 in the forward direction. As shown in FIG. 6, the shaft 14 and gear 28 rotate together at the same speeds; the solid and dashed lines 150, 152 are coincident because the propulsive torque is in the forward direction through the locking element 30A.

In Step 210, in preparation for the shift, the actuator moves to the first position—Position A, repositioning the locking elements 30B associated with reverse torque of the 1^{st} gear assembly/ratio 18 from the deployed position to a nondeployed position and deploys the locking elements 38A, 38B of the 2^{nd} gear assembly/ratio 20. As the shift assembly prepares for the power on upshift from the 1^{st} gear assembly/ratio 18 to the 2^{nd} gear assembly/ratio 20, the locking element 30B of the first controllable one-way clutch or coupling assembly 23 associated with the reverse torque is disengaged or nondeployed, placed in the pocket 24B of the pocket plate 24. In this position, the passive one-way clutch or coupling assembly 21 remains on and transfers torque in the forward direction, while the first controllable one-way clutch or coupling assembly 23 is turned off, wherein no torque is transferred in the reverse or regenerative direction.

In Step 220, if desired, the method determines if the locking elements 30B are nondeployed. If not nondeployed, the method returns to step 210. If the locking elements 30B are disengaged or nondeployed, the method proceeds to step 230. Whether the locking elements 30B are engaged or deployed may be determined by speed, position, and torque sensors that monitor the respective parameters of the components.

In Step 230 the system decelerates the speed of the first shaft 14. While the locking elements 38A, 38B of the second and third controllable one-way clutches or coupling assemblies 31, 33 are deployed in Step 210, deployment may take place in no particular order. For example, instead of the locking elements 38A, 38B of the second and third controllable one-way clutches or coupling assemblies 31, 33 being deployed prior to the deceleration of the first shaft 14, they may be deployed at the start of or during the deceleration of the first shaft 14. Deployment of the locking elements 38A, 38B associated with the second gear assembly/ratio 20 may occur before, during, or after initially decelerating the speed of the first shaft 14. Deployment may also occur prior to or concurrent with repositioning the locking elements 30B to nondeployed.

The reverse locking element 38B may be deployed without engaging the corresponding notch plate because the locking element 38B overruns. The forward locking element 38A may be deployed without engaging the corresponding notch plate 34 because the locking element 38A ratchets. The relative rotational motion between the locking element 38A and the notch plate 34 is at a high enough magnitude that the locking element is unable to or cannot move deep enough into a notch 34A to engage and stop relative rotational motion between the pocket plate 32 and the notch plate 34. Instead of engaging a notch 34A, the locking element 38A skips out of the notch 34A, allowing continued relative motion.

FIG. 6 shows the speed 150 of the first shaft 14 decelerating and diverging at point 156 from the speed 152 of the gear 28 of the first gear assembly/ratio 18. While the speed 150 of the first shaft 14 continues to decelerate, a vehicle propulsion mechanism connected to the second shaft 16, for example, the vehicle wheels, rotates the second shaft 16. As the vehicle connected to the second shaft 16 continues in a forward direction, the second shaft 16 acts through the 1^{st} gear assembly/ratio 18, including gear 29, to continue to rotate the gear 28. The rotation rate of gear 28 gradually slows as vehicle drag, friction, and other elements act on the vehicle. In one example of the present system, the shaft 14 is coupled to and driven by an electric motor. With an electric motor, the motor speed can be reduced rapidly. For example, the motor speed, and correspondingly the speed 150 of the first shaft 14, may go from 2000 to 1500 RPM in less than a second.

When the first shaft 14 rotates slower than the gear 28, the gear 28 overruns the first shaft 14, putting the locking element 30A of the passive one-way clutch or coupling assembly 21 in an overrun condition or state. Reduction of the speed 150 of the first shaft 14 automatically disconnects the locking element 30A of the passive one-way clutch or coupling assembly 21. It no longer provides forward torque as the gear 28 rotates faster than the first shaft 14.

When the first shaft 14 rotates faster in the same direction than the gear 36, for example, the pocket plate 32 and notch plate 34 are rotating forward, the deployed locking element 38A, the forward torque transmitting element, ratchets, is in a ratcheting condition or state. Instead of engaging, the deployed locking element 38A skips out of, or passes over, the notch 34A in the notch plate 34 connected to or part of the gear 36 and transfers no torque from the first shaft 14 to the gear 36. When the first shaft 14 rotates in the same direction, for example, the pocket plate 32 and notch plate 34 are rotating forward, the deployed locking element 38B, the reverse torque transmitting element, is in an overrun condition or state and transfers no torque from the first shaft 14 to the gear 36

FIG. 6 shows the ratcheting condition or state of the locking element 38A continuing as the speed 150 of the first shaft 14 decelerates until the speed of the first shaft 14 reaches point 158, where the deployed locking element 38A exits the ratcheting condition or state and engages the notch 34A in the notch plate 34 connected to or part of the gear 36, the deployed locking element 38A no longer ratchets and engages a corresponding notch 34A in the notch plate 34. The engagement happens at a predetermined speed differential between the speed 150 of the first shaft 14 and the speed 154 of the gear 36 of the 2^{nd} gear assembly/ratio 20. A predetermined speed differential is when relative components, for example the locking element and notch plate, are within a predetermined window of rotational speed. In one example, a predetermined window of rotational speed is a rotational speed difference, in the same direction of rotation, between components of 200 RPM or less. In another example, the rotational speed difference may be between 50 RPM and 100 RPM. In another example, the rotational speed difference is at or below 50 RPM. While shown as a point 158, this is for illustration only as point 158 typically encompasses a range.

When the locking element 38A engages the notch plate 34 portion of the gear 36 at point 158 the motor speed 150 rapidly reduces to the speed of the second gear 36 at point 159. Because the speed 154 of the second gear 36 is initially controlled by the inertia of the system, typically the motor speed reduces to the speed of the second gear 36. In some instances, there may be a slight blip or increase in speed of the second gear 36 once the locking element 38A engages.

Although the locking elements 38A, 38B of the second and third controllable one-way clutches or coupling assemblies 31, 33 are deployed and at point 158 engage respective notches 34A, 34B in the notch plate, connected to or part of the gear 36 coupling the first shaft 14 and the gear 36 no torque, or at best minimal torque, is transmitted from the first shaft 14 to the gear 36 upon initial deployment during a power on upshift from 1^{st} gear to 2^{nd} gear. FIG. 6 shows the speed 150 of the first shaft 14 decreasing from point 158 to point 159 wherein the speed 150 of the first shaft synchronizes with the speed of the gear 36 or the 2^{nd} gear assembly/ratio 20. Synchronize means relative rotating components are rotating within a predetermined window of rotational speed. In one example, a predetermined window of rotational speed is a difference of ±100 RPM. While defined as points 156, 159, they may not be discrete points but encompass a range.

The ratcheting speed, or speed at which the locking element 38A no longer ratchets but engages at point 158, is the difference in relative rotational motion between the speed 150 of the first shaft 14 and the speed 154 of the second gear 36 are within the predetermined window of rotational speed, to provide a smooth transition or shift and/or remove or reduce the occurrence of jerk or a perceived harsh shift. For example, the smaller the difference in relative rotational motion, or the speed at which the ratcheting locking element 38A engages the notch 34A, the smoother the shift and reduced occurrence of jerk. After engagement of the locking element 38A, the speed 150 of the first shaft 14 continues to decrease from point 158 to point 159, from the engagement point 158 to the synchronization point 159. Because the locking element 38A is already engaged at the synchronization point 159, propulsion torque can be applied to the first shaft 14, which is then transferred to the second gear 36 with a minimal transition period or curve, for example, fine or precise motor control to gradually slow the speed 150 of the first shaft 14 to match the speed of the gear 36.

In step 240, if desired, the method determines if the locking elements 38A, 38B associated with the second gear assembly/ratio 20 are deployed. If not deployed, the method returns to step 210. If the locking elements 38A, 38B are deployed, the method proceeds to step 230. Whether the locking elements 30B are engaged or deployed may be determined by speed, position, and torque sensors that monitor the respective parameters of the components.

In step 245 the method determines if the speed 150 of the first shaft is synchronized with the speed of the gear 36 of the 2^{nd} gear assembly/ratio 20. If not synchronized, the method returns to step 230. If synchronized, the method proceeds to step 250. In step 250 the system accelerates the first shaft 14 and provides torque through the 2^{nd} gear assembly/ratio 20. In FIG. 6, the respective speeds 150, 154 of the first shaft 14 and the gear 36 are equal because the propulsive torque is in the forward direction through the locking element 38A, and the solid and dotted lines 150, 154 are coincident.

In step 260, once coupled, the controllable clutches of the second controllable one-way clutch or coupling assembly 31 transfer torque from the motor through the first shaft 14, the second gear assembly/ratio 20, and the second shaft 16 to the vehicle propulsion mechanism, for example, the vehicle wheel. The system operates in the second gear assembly/ratio 20 and operates in forward, reverse, and regeneration modes.

FIGS. 5 and 6 illustrate an upshift from 1^{st} gear to 2^{nd} gear for forward propulsion torque. The passive one-way clutch or coupling assembly 21 and the first controllable one-way clutch or coupling assembly 23 are both in an engaged or deployed position. In preparing to shift, while still in 1^{st} gear, the passive one-way clutch or coupling assembly 21 remains in an engaged position, and the first controllable one-way or coupling assembly 23 is placed in a disengaged or nondeployed position, the first controllable one-way clutch or coupling assembly 23 is off. After the coupling assembly 23 is nondeployed, or while the coupling assembly 23 is moving to a nondeployed position, the coupling assemblies 31, 33 are moved to a deployed position wherein the coupling assembly 31 ratchets and the coupling assembly 33 overruns. Engagement of the locking element 38A occurs based on the vehicle speed and the motor speed. Because the vehicle speed can be monitored, and the motor speed changes rapidly, it is possible to control the motor speed to control engagement and torque transfer of the coupling assemblies 31, 33. In the 2^{nd} gear node, the second and third controllable one-way clutches or coupling assemblies 31, 33 are in an engaged or deployed position with the passive one-way clutch coupling assembly 21 in a deployed position, and the first controllable one-way clutch or coupling assembly 23 in a disengaged or nondeployed position, the first controllable one-way clutch or coupling assembly 23 is off.

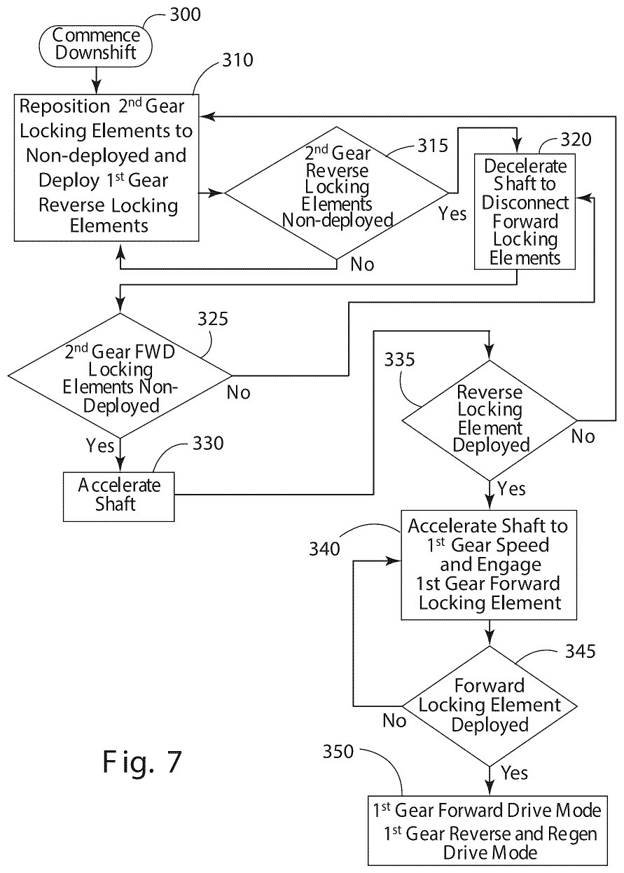

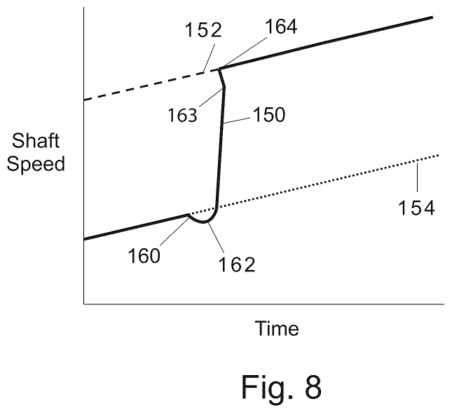

FIG. 7 is a flowchart of one example of the inventive system and method showing a downshift from 2^{nd} gear to 1^{st} gear, wherein the power transmission system or assembly 10 shifts from 2^{nd} gear forward propulsive torque to 1^{st} gear forward propulsive torque. FIG. 8 is a motor speed over time diagram illustrating the speed, solid line 150, of the first shaft 14, the speed, dashed line 152, of the gear 28, and the speed, dotted line 154, of the gear 36.

FIG. 7 shows the method begins in step 300 with a signal or command to commence a downshift from 2^{nd} gear forward to 1^{st} gear forward. Initially, the actuator 40 is in the first position—Position A. The locking elements 38A, 38B of the second and third controllable one-way clutches or coupling assemblies 31, 33 are deployed. Each extends outward from its respective pocket 32A, 32B of the pocket plate 32. Because the locking element 38A is deployed, it couples the first shaft 14 and gear 36 in the forward direction, wherein they rotate together at the same speed, the solid and dotted lines 150, 154 are coincident because the propulsive torque is in the forward direction through the locking element 38A. The locking element 30B of the first controllable one-way clutch or coupling assembly 23 associated with 1^{st} gear reverse torque is disengaged or nondeployed.

In step 310, in preparation for the downshift, the actuator 40 moves to the third position—Position C and repositions the locking elements 38A, 38B of the second and third controllable one-way clutch or coupling assembly 31 in a nondeployed position. However, because the locking element 38A is still carrying forward torque, it may remain in a deployed position and still engaged. In step 310, the system also deploys the 1^{st} gear reverse locking elements 30B of the first controllable one-way clutch or coupling assembly 23, which includes a ratcheting locking element 30B. The locking element 30B is deployed at the same time the locking elements 38A, 38B associated with the second and third coupling assemblies 31, 33 are repositioned to nondeployed. Initially, because the relative rotational speed between the shaft 14 and the speed 152 of the first gear 28 is high enough, above the predetermined window of rotational speed, such that the locking element 30B ratchets, it does not engage the notches 26B in the notch plate 26 coupled to the 1^{st} gear 28. The 1^{st} gear reverse locking element 30B is capable of both ratcheting and overrunning.

In Step 315, if desired, the method determines if the locking elements 38B are nondeployed. If not deployed, the method returns to step 310. If the locking elements 38B are nondeployed, the method proceeds to step 320. Whether the locking elements 38B are disengaged or nondeployed may be determined by speed, position, and torque sensors that monitor the respective parameters of the components.

In step 320 the system decelerates the speed 150 of the first shaft 14 to remove torque and reposition the forward locking element 38A to a nondeployed position. FIG. 8 shows the speed 150 of the first shaft 14 diverges, falls below the speed of the gear 36 starting at point 160. Decreasing the speed 150 of the first shaft 14 below that of the speed 154 of the gear 36 removes the forward torque on the locking element 38A, allowing disengagement wherein the force of the actuation member or spring 60A acts on the locking element 38A moving it to the nondeployed position.

Step 325 determines if the locking elements 38A are nondeployed. If not nondeployed, the method returns to step 320. If the locking elements 38A are nondeployed, the method proceeds to step 330. Whether the locking elements 38A are disengaged or nondeployed may be determined by speed, position, and torque sensors that monitor the respective parameters of the components.

Step 330 accelerates the speed 150 of the first shaft 14. As shown in FIG. 8, the speed 150 of the first shaft 14 accelerates from a low point 162 of the speed 150, passes the speed 154 of the gear 36, and continues toward the speed 152 of the gear 28.

Step 330 continues the acceleration and increases the speed 150 of the first shaft 14 until it reaches the predetermined window of rotational-speed wherein the locking element 30B engages.

Referring to FIG. 8, as the speed 150 of the first shaft 14 continues to accelerate the rotational speeds 150,152 of the first shaft 14 and corresponding locking elements 30B gear 28 of the first gear assembly/ratio 18 reach a relative rotational speed, within the predetermined window of rotational speed, for example point 163, wherein the locking element 30B of the first controllable one-way clutch or coupling assembly 23 engages the notch 26B in the notch plate 26 connected to the gear 28. The difference in relative rotational motion between the speed 150 of the first shaft 14 and the speed 152 of the first gear 28 is predetermined to provide a smooth transition and remove or reduce the occurrence of jerk or a perceived harsh shift.

After engagement of the locking element 30B, the speed 150 of the first shaft 14 continues to increase from point 163 to point 164, from the engagement point 163 to the synchronization point 164. Because the locking element 30B engages at engagement point 163 the speed of the first shaft 14 rapidly increases, that is the speed 152 of the first gear 28 applies torque to rapidly synchronize the speed 150 of the first shaft 14 with the speed 152 of the first gear 28. There may be a slight blip or decrease in the speed 152 of the first gear 28 as the respective speeds 150 and 152 synchronize. Because the respective speeds 150 and 152 are now synchronized, the locking element 30A of the passive one-way clutch or coupling assembly 21 engages, connects, and begins to transfer torque as the speed 150 of the first shaft 14 increases, wherein the speed 150, 152 of the first shaft 14 and the gear 28 is the same, the solid and dashed lines are coincident because the propulsive torque is in the forward direction through the locking element 30A.

Using the ratchet locking element 30B reduces the need to gradually reduce the acceleration of the speed 150 of the first shaft 14 as it reaches the speed 152 of the first gear 28 to achieve a smooth shift. Whereby the motor speed, and corresponding speed 150 of the first shaft 14, are increased without the need for a transition period or curve, for example using fine motor control to gradually reduce the acceleration of the speed 150 of the first shaft 14 to match the respective speeds 150, 152 and to reduce the jerk or harsh shift. The synchronization takes place based on engagement of the first gear reverse locking element 30B after which the locking element 30A of the passive one-way clutch or coupling assembly 21 engages, connects, and begins to transfer torque, wherein the speed 150, 152 of the first shaft 14 and the gear 28 is the same, the solid and dashed lines are coincident because the propulsive torque is in the forward direction through the locking element 30A.

In step 335, if desired, the method determines if the locking elements 30B are engaged or deployed. If not deployed, the method returns to step 310. If the locking elements 30B are engaged or deployed, the method proceeds to step 340. Whether the locking elements 30B are engaged or deployed may be determined by speed, position, and torque sensors that monitor the respective parameters of the components.

In step 340, the system accelerates, continues to increase the speed of the first shaft 14 and passively engages the locking elements 30A to provide forward torque and propulsion through the first gear assembly/ratio 18 in the forward mode. FIG. 8 shows the first shaft 14 rotates at the same forward speed as the gear 28 of the first gear assembly/ratio 18, and the lines 150 and 152 are coincident.

In step 345, if desired, the method determines if the locking elements 30A are engaged or deployed. If not deployed, the method returns to step 340. Whether the locking elements 30A are engaged or deployed may be determined by speed, position, and torque sensors that monitor the respective parameters of the components.

In step 350 the system operates in 1^{st} gear, the first gear assembly/ratio 18, in forward, reverse, and regeneration modes. In the regeneration mode the system provides regeneration torque—regenerative braking.

FIGS. 7 and 8 illustrate a downshift from 2^{nd} gear to 1^{st} gear in forward propulsive torque. Initially the system moves the locking element 30B to a deployed position and moves the locking elements 38A, 38B to a nondeployed position. However, the locking element 38A associated with forward torque remains in an engaged or deployed position, extending from the pocket 32A due to forward torque. The locking element 38B, associated with reverse and regenerative torque, is disengaged or nondeployed, is placed in, and remains in the pocket 32B of the pocket plate 32. The locking element 30B, while deployed, ratchets and does not engage the notch plate 26 attached to the gear 28. The shift continues by accelerating the motor to the rotational speed of the 1^{st} gear assembly/ratio 18 and corresponding gear 28. The first shaft 14 and motor overrun the locking element 30A as the rotational speed 150 of the first shaft 14 exceeds that of the gear 28 and the locking element 30B continues to ratchet. The motor increases the rotational speed 150 of the first shaft 14 until it reaches the predetermined window of rotational speed of the locking element 30B at which point the locking element 30B no longer ratchets, it engages a notch 26B in the notch plate 26, and synchronizes the rotational speed of the 1^{st} gear assembly/ratio 18 and corresponding gear 28 with the speed of the first shaft 14. Once synchronized, the forward locking element 30A stops overrunning and engages the gear 28 and provides forward torque to the gear 28 and correspondingly, the 1st gear assembly/ratio 18. The locking element 30B of the first controllable one-way clutch or coupling assembly 23 is also engaged or deployed, extends outward from the pocket 24A of the pocket plate 24, and transmits regenerative torque from the second shaft 16 to the first shaft 14 and, correspondingly the motor.

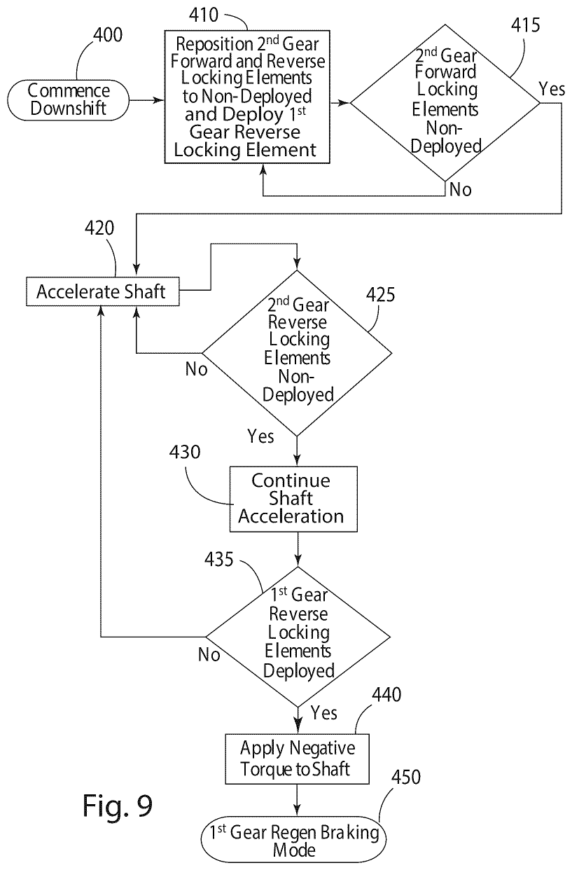

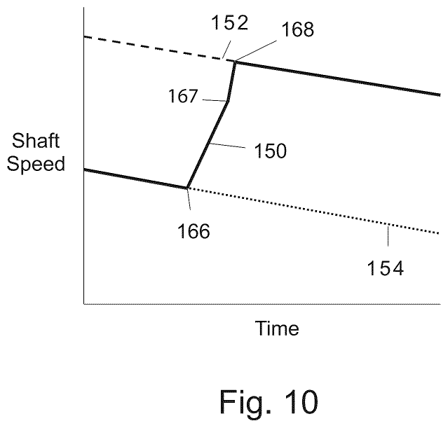

Referring to the drawings, FIG. 9 is a flowchart of one example of the inventive system and method showing a downshift from 2^{nd} gear to 1^{st} gear, wherein the power transmission system or assembly 10 downshifts from 2^{nd} regenerative torque—regenerative braking to 1^{st} gear regenerative torque—regenerative braking. FIG. 10 is a speed over time diagram illustrating the speed, solid line 150, of the first shaft 14, the speed, dashed line 152, of the gear 28, and the speed, dotted line 154, of the gear 36.

FIG. 9 shows the method begins in step 400 with a signal or command to commence a downshift from 2^{nd} regenerative torque—regenerative braking to 1^{st} gear regenerative torque—regenerative braking. Initially, the actuator 40 is in the first position—Position A. The locking elements 38A, 38B of the second and third controllable one-way clutches or coupling assemblies 31, 33 are deployed and may transfer either forward or regenerative torque. As shown in FIG. 10, because the locking elements 38A, 38B are deployed, the speed 150 of the shaft 14 and the speed 154 of the gear 36 are the same, and the solid line and dotted lines are coincident because the regenerative torque is in the forward direction through the locking element 38B.

In step 410, in preparation for the shift, the actuator moves to the third position—Position C. The locking elements 38A, 38B are repositioned from the initial deployed position to a nondeployed position and the locking elements 30B of the first controllable one-way clutch or coupling assembly 23 are deployed. Initially, because of the speed differential between the gear 28 and first shaft 14 is above the predetermined window of rotational speed, the locking elements 30B ratchet and do not engage. However, because the locking element 38B is still carrying torque, it may remain in a deployed position and still engaged.

In step 415, if desired, the method determines if the locking elements 38A are nondeployed. If not nondeployed, the method returns to step 410. If the locking elements 38A are nondeployed, the method proceeds to step 420. Whether the locking elements 38A are disengaged or nondeployed may be determined by speed, position, and torque sensors that monitor the respective parameters of the components.

In step 420 the system accelerates the speed 150 of the first shaft 14 to remove torque and reposition the reverse locking elements 38B to a nondeployed position. Deployment of the locking elements 30B associated with the first gear assembly/ratio 18 may occur before, during, or after initially accelerating the speed of the first shaft 14.

FIG. 10 shows the speed 150 of the first shaft 14 accelerates at point 166. Wherein the speed 150 of the first shaft 14 and the speed 154 of the gear 36 diverge, with the speed of the first shaft 14 increasing above the speed of the gear 36 starting at point 166. Increasing the speed 150 of the first shaft 14 above the speed 154 of the gear 36 removes any reverse torque on the locking element 38B, allowing disengagement. For example, the force of the return biasing member or spring 61B acts on the locking element 38B once the torque is removed to move it to the nondeployed position.

Step 425 determines if the locking elements 38B are nondeployed. If not nondeployed, the method returns to step 410. If the locking elements 38B are nondeployed, the method proceeds to step 430. Whether the locking elements 38B are disengaged or nondeployed may be determined by speed, position, and torque sensors that monitor the respective parameters of the components.

In Step 430 the system continues to accelerate the speed 150 of the first shaft 14 to the speed 152 of gear 28. The locking element 30B, while deployed, ratchets and does not engage the notch plate 26 attached to the gear 28. The motor increases the rotational speed 150 of the first shaft 14 until it reaches point 167, the predetermined window of rotational speed of the locking element 30B, at which point the locking element 30B no longer ratchets, engages a notch 26B in the notch plate 26, connected to or part of the gear 28 coupling the first shaft 14 and the gear 28. Engaging the locking element 30B synchronizes the rotational speed of the 1^{st} gear assembly/ratio 18 and corresponding gear 28 with the speed of the first shaft 14. FIG. 10 shows the speed 150 of the first shaft accelerating toward the speed 152 of the gear 28 and reaching point 167, wherein the locking element 30B engages. Once engaged, the speed 152 of the gear 28 and the speed 150 of the first shaft 14 quickly synchronize at point 168 wherein the locking element 30B engages and couples the first shaft 14 and the gear 28. When engaged, the one-way clutch or coupling assembly 23 enables torque transfer for regeneration, wherein decreasing the speed of the gear 28 correspondingly decreases the speed of the first shaft 14 and the solid line and dashed lines are coincident because the regenerative torque is in the forward direction through the locking element 30B.

Step 435, if desired, determines if the locking elements 30B are deployed. If not deployed, the method returns to step 420. If the locking elements 30B are deployed, the method proceeds to step 440. Whether the locking elements 30B are engaged or deployed may be determined by speed, position, and torque sensors that monitor the respective parameters of the components.

In Step 440 the system applies a negative or reverse torque to the first shaft 14. The negative or reverse torque resulting from shaft 16 driving the first gear assembly/ratio 18 and, correspondingly, the first shaft 14. In step 450 the system operates in 1^{st} gear regeneration mode.

FIGS. 9 and 10 illustrate a downshift from 2^{nd} gear to 1^{st} gear, wherein the power transmission system or assembly 10 downshifts from 2^{nd} regenerative torque—regenerative braking to 1^{st} gear regenerative torque—regenerative braking. Initially, the locking elements 38A, 38B of the second and third controllable one-way clutches or coupling assemblies 31, 33 are engaged and may transfer either forward or regenerative torque. As the shift assembly prepares to downshift from 2^{nd} gear to 1^{st} gear, the locking element 38A associated with forward torque is disengaged or nondeployed, is placed in, and remains in the pocket 32A of the pocket plate 32. The locking element 38B, associated with reverse and regenerative torque, remains in an engaged or deployed position, extending from the pocket 32B. The locking element 30B is repositioned to a deployed position and initially ratchets. The shift continues by accelerating the motor to the rotational speed of the 1^{st} gear assembly/ratio 18 and corresponding gear 28. The first shaft 14 and motor overrun the locking element 38B as the rotational speed of the first shaft 14 exceeds that of the gear 36. The motor increases the rotational speed of the first shaft 14 until the locking element 30B reaches the engagement point 167, stops ratcheting and engages a notch 26B in the notch plate 26 associated with the 1^{st} gear assembly/ratio 18 and corresponding gear 28, at which point the gear 28 and first shaft 14 synchronize speeds. After the locking element 30B engages the gear 28, the locking element 30B provides regenerative torque to the gear 28 and, correspondingly, the 1^{st} gear assembly/ratio 18. The locking element 30B of the first controllable one-way clutch or coupling assembly 23 is engaged or deployed, and the locking element 30B extends outward from the pocket 24A of the pocket plate 24, engages a notch 26B in the notch plate 26 and transmits regenerative torque from the second shaft 16 to the first shaft 14 and correspondingly the motor.

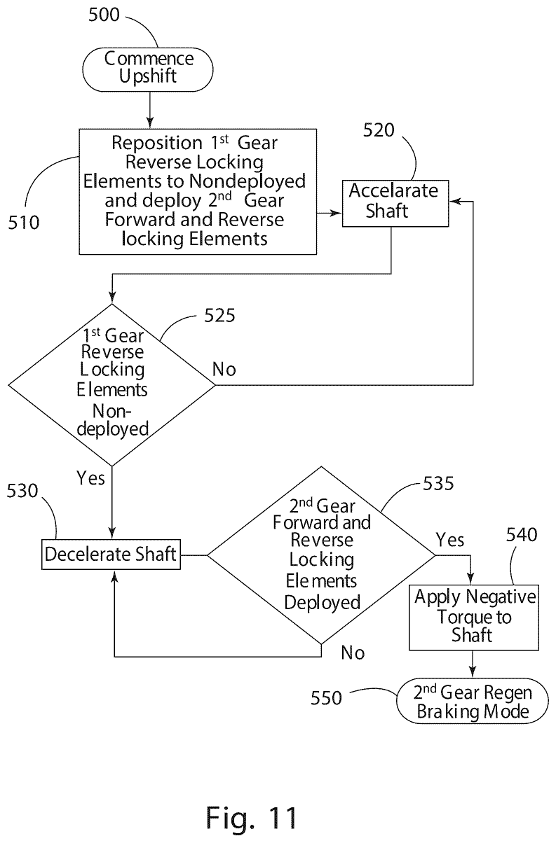

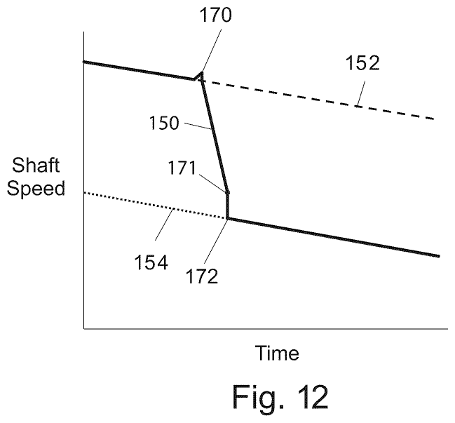

FIG. 11 is a flowchart of one example of the inventive system and method illustrating an upshift from 1^{st} gear to 2^{nd} gear, wherein the power transmission system or assembly 10 upshifts from 1^{st} gear regenerative torque—regenerative braking to 2^{nd} gear regenerative torque—regenerative braking. FIG. 12 is a speed over time diagram illustrating the speed, solid line 150, of the first shaft 14 speed, dashed line 152, of the gear 28, and the speed, dotted line 154, of the gear 36.

FIG. 11 shows the method begins in step 500 with a signal or command to commence an upshift from 1^{st} gear regenerative torque—regenerative braking to 2^{nd} gear regenerative torque—regenerative braking. Initially, the actuator 40 is in the third position—Position C. The forward locking elements 30A of the passive one-way clutch or coupling assembly 21 and the reverse torque transmitting locking element 30B of the controllable one-way clutch or coupling assembly 23 are deployed and may transfer forward and reverse regenerative torque. Because the locking elements 30A, 30B are deployed, the speed 150 of the shaft 14 and the speed 152 of the gear 28 are the same, and the solid line and the dashed line are coincident because the regenerative torque is in the forward direction through the locking element 30B.

In step 510, in preparation for the upshift from 1^{st} to 2^{nd} gear, the actuator moves to the first position—Position A. The locking elements 30B are repositioned from the initial deployed position to a nondeployed position. However, because the locking element 30B is still carrying torque it may remain in a deployed position and still engaged. The locking elements 38A and 38B associated with 2^{nd} gear forward and reverse are deployed, with the locking elements 38A ratcheting and the locking elements 38B overrunning.

In step 520 the system accelerates the speed 150 of the first shaft 14 to a point 170 above the speed 152 of the gear 28, wherein the speed 150 of the first shaft 14 and the speed 152 of the gear 28 diverge, with the speed of the shaft 14 increasing above the speed of the gear 28 for a brief period. The speed 150 of the shaft 14 increases above the speed 152 of the gear 28 at the point 170 to remove torque on the locking element 30B, allowing disengagement. The force of the return biasing member or spring 55B acts on the locking element 30B once the torque is removed to move it to a nondeployed position.

Step 525 determines if the locking elements 30B are nondeployed. If not nondeployed, the method returns to step 520. If the locking elements 30B are nondeployed, the method proceeds to step 530. Whether the locking elements 30B are disengaged or nondeployed may be determined by speed, position, and torque sensors that monitor the respective parameters of the components.

In Step 530 the system decelerates the speed 150 of the first shaft 14 toward the speed 154 of the second gear 36. The deployed locking element 38A ratchets and does not engage the notch plate 34 attached to the gear 36 and the deployed locking element 38B overruns the notches 34B in the notch plate 34. The motor reduces the rotational speed 150 of the first shaft 14 until it reaches the predetermined window of rotational speed of the locking element 38A, at which point the locking element 38A no longer ratchets and engages a notch 34A in the notch plate 34 and synchronizes the rotational speed of the second gear assembly/ratio 20 and corresponding gear 36 with the speed of the first shaft 14. FIG. 12 shows the speed 150 of the first shaft 14 decelerating toward the speed 154 of the gear 36 and reaching point 171, wherein the locking element 38A engages. Once engaged the speed 154 of the gear 36 and the speed 150 of the first shaft for 14 quickly synchronizes at point 172. There may be a slight blip or increase in the speed 154 of the second gear 36 as the respective speeds 150 and 154 synchronize. Continued deceleration of the motor engages the locking element 38B coupling the first shaft 14 and gear 36 enabling torque transfer for regeneration. The solid line and dashed lines are coincident because the regenerative torque is in the forward direction through the locking element 38B. Deployment of the locking elements 38A, 38B associated with the second gear assembly/ratio 20 may occur before, during, or after initially decelerating the speed of the first shaft 14.

Step 535 determines if the locking elements 38A, 38B associated with the second gear assembly/ratio 20 are deployed. If not deployed, the method returns to step 510. If the locking elements are deployed, the method proceeds to step 540. Whether the locking elements 38A, 38B are engaged or deployed may be determined by speed, position, and torque sensors that monitor the respective parameters of the components.

In Step 540 the system applies negative or reverse torque to the shaft 14. The negative or reverse torque resulting from shaft 16 driving the second gear assembly/ratio 20 and, correspondingly, the first shaft 14. In Step 550 the system operates in 2^{nd} gear regeneration mode.

FIGS. 11 and 12 illustrate an upshift from 1^{st} gear to 2^{nd} gear, wherein the power transmission system or assembly 10 upshifts from 1^{st} gear regenerative torque—regenerative braking to 2^{nd} gear regenerative torque—regenerative braking. As shown, both locking element 30A of the passive one-way clutch or coupling assembly 21 and the locking element 30B of the first controlled one-way clutch or coupling assembly 23 are engaged or deployed, extending outward from respective pockets 24A, 24B of the pocket plate 24, wherein the locking elements 30A, 30B are engaged and may transfer either forward torque and regenerative torque. In preparation for the shift, the locking elements 38A and 38B associated with 2^{nd} gear forward and reverse are also deployed, with the locking elements 38A ratcheting and the locking elements 38B overrunning. As the shift assembly prepares to upshift from the 1^{st} gear to the 2^{nd} gear, the locking element 30A engages and transfers a slight amount of, or increases, forward torque enabling the locking element 30B associated with the reverse or regenerative torque to disengage, move to nondeployed and remain in the pocket 24B of the pocket plate 24. The locking element 30A associated with the forward torque remains engaged or deployed and extends out of the pocket 24A. The shift continues by decelerating the motor and, correspondingly, the first shaft 14 toward the rotational speed of the 2^{nd} gear assembly/ratio 20 and corresponding gear 36. As the motor speed decreases the gear 28, and correspondingly the 1^{st} gear assembly/ratio 18, overruns the forward locking element 30A. The second shaft 16 and corresponding 1^{st} gear assembly/ratio 18, including the gear 28, overruns the locking element 30A as the rotational speed of the gear 28 exceeds that of the first shaft 14 and motor. The motor decreases the rotational speed of the first shaft 14 until it reaches the engagement point of the locking element 38A. The relative rotational speeds of the first shaft 14 and the gear 36 are such that the locking element 38A engages the notch plate 34 associated with the 2^{nd} gear assembly/ratio 20 and corresponding gear 36 and synchronizes the speed 150 of the first shaft 14 and speed 154 of the gear 36. Shortly thereafter, the locking element 38B engages a notch 34 and transmits regenerative torque from the second shaft 16 to the first shaft 14 and, correspondingly the motor. The second and third controllable one-way clutches or coupling assemblies 31, 33 are engaged or deployed to transfer forward, regenerative, and reverse torque using the 2^{nd} gear assembly/ratio 20. The 1^{st} gear assembly/ratio 18 transfers no torque even though the locking element 30A of the passive one-way clutch or coupling assembly 21 remains engaged/deployed. The gear 28 continuously overruns the locking element 30A as long as the first shaft 14 is coupled to the 2^{nd} gear assembly/ratio 20.

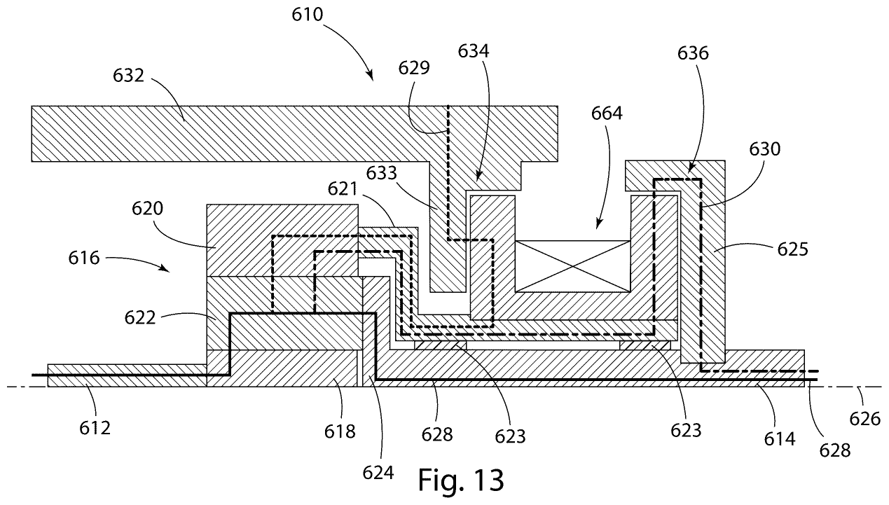

FIGS. 13, 14-14B, and 15-15B illustrate a power transmission system or assembly 610, according to another example of the present invention. The power transmission system or drive assembly 610 includes an input or first shaft 612, for example, a drive member connected to an electric or traction motor, and an output or second shaft 614, for example, a driven member connected to a vehicle wheel. The power transmission system or drive assembly 610 includes a planetary gear system or gearset, seen generally at 616. An electric motor (not shown) drives the input or first shaft 612. The planetary gearset 616 includes a sun gear 618, a ring gear 620, and planet gears 622 between the sun gear 618 and the ring gear 620. A planet carrier 624 holds the planet gears 622 at a predetermined radii from the centerline or rotational axis 626 of the sun gear 618 while allowing the planet gears 622 to rotate. The planet gears 622 mesh with the sun gear 618 and the ring gear 620. The sun gear 618 of the planetary gearset 616 is coupled with or joined to the input or first shaft 612. The planet carrier 624 of the planetary gearset 616 is coupled with or joined to the output or second shaft 614.

The input or first shaft 612 and sun gear 618 rotate together. The output or second shaft 614 and planet carrier 624 rotate together, wherein the planet carrier 624 rotates independently of the input or first shaft 612 and drives the output or second shaft 614.

In the present example, a member 621, supported by bearings 623 rotates about the axis 626 on the output shaft 614. The member 621 is fixed to the ring 620. An actuator 664 mounted to the member 621 operates to couple the member 621 and the ring gear 622 to ground 632 through the ground plate 633 connected to ground 632. Ground 632, as used herein, is a stationary component, for example, a casing, housing, or other component that does not move relative to the components of the planetary gearset 616. The actuator 664 also operates to couple the member 621 and the ring gear 622 to the planet carrier 624/output shaft 614 through the output/planet carrier plate 625 connected to the planet carrier 624/output shaft 614. The output/planet carrier plate 625 may be a notch plate.

The power transmission system or assembly 610 includes a power or torque path 628 extending from the input or first shaft 612 through the sun gear 618 through planet gears 622 and planet carrier 624 to the output or second shaft 614. The power transmission system or assembly 610 includes a 1^{st} gear ratio, the torque reaction path 629 resulting from a first coupling assembly or mechanism, seen generally at 634, coupling the member 621 and correspondingly the ring gear 620 to ground 632. In one example, the 1^{st} gear ratio is a reduction, for example, a 3:1 ratio. The power transmission system or drive assembly 610 includes a 2^{nd} gear ratio, the torque reaction path 630 resulting from a second coupling assembly or mechanism, seen generally at 636, coupling the member 621 to the planet carrier 624/output or second shaft 614. In the present example, the 2^{nd} gear ratio is a direct drive or 1:1 ratio. The 1^{st} gear ratio and 2^{nd} gear ratio have a common input, the input member or first shaft 612 and a common output, the output or second shaft 614.

The system or assembly 610 connects the input or first shaft 612 with the output or second shaft 614 through either the 1^{st} gear ratio, the ring gear 620 and ground 632, or the 2^{nd} gear ratio, the ring gear 620 and the planet carrier 624.

In the 1^{st} gear ratio, the first coupling assembly or mechanism 634 couples or connects the ring gear 620 with ground 632 and the second coupling assembly or mechanism 636 decouples or disconnects the ring gear 620 from the planet carrier 624 wherein the ring gear 620 remains stationary and the planet carrier 624 rotates relative to the ring gear 620. In the 2^{nd} gear ratio the first coupling assembly or mechanism 634 decouples or disconnects the ring gear 620 from ground 632. The second coupling assembly or mechanism 636 couples or connects the ring gear 620 with the planet carrier 624, wherein the ring gear 620 and planet carrier 624 rotate together with the ring gear 620 and freely with respect to the stationary member or ground 632.

In the present example, the first coupling assembly or mechanism 634 includes a passive one-way clutch or coupling assembly 638 and a controllable one-way clutch or coupling assembly 640, each operable to engage/disengage and connect/disconnect the ring gear 620 and ground 632 in opposite directions of rotation. The passive one-way clutch or coupling assembly 638 includes struts or locking elements 642 operable to engage/disengage and connect/disconnect the ring gear 620, through member 621, and ground 632 in one direction of rotation, for example, clockwise. The controllable one-way clutch or coupling assembly 640 includes struts or locking elements 644 operable to engage/disengage and connect/disconnect the ring gear 620, through member 621, and ground 632 in the opposite direction of rotation, for example, counterclockwise. The first coupling assembly or mechanism 634 includes a pocket plate 648 and a notch plate 650. The pocket plate 648 is connected to the ring gear 620, through the member 621, and the notch plate 650 is connected to ground 632, for example the transmission case or housing, through the member or ground plate 633. The locking elements 642, 644 associated with the first coupling assembly or mechanism 634 are located in the pocket plate 648. The first coupling assembly or mechanism 634 uses two one-way clutches to transmit torque in both directions of rotation. The first and second one-way clutches or coupling assemblies 638, 640 of the first coupling assembly or mechanism 634 enable both forward and reverse torque, wherein the passive one-way clutch or coupling assembly 638 controls torque transfer in a direction of rotation, and the controllable one-way clutch or coupling assembly 640 controls torque transfer in a second direction of rotation. For example, the first direction of rotation, clockwise, corresponds to forward drive torque, and the second direction of rotation, counterclockwise, corresponds to reverse drive torque.

The second coupling assembly or mechanism 636 includes a pair of controllable one-way clutches or coupling assemblies 652, 654 having controllable, deployable locking elements, wherein the state of the clutch, activated or deactivated, can be selected or controlled. The second coupling assembly or mechanism 636 includes a first set of struts or locking elements 656 operable to engage/disengage and connect/disconnect the planet carrier 624 and ring gear 620 in one direction of rotation, for example, clockwise and a second set of struts or locking elements 658 operable to engage/disengage and connect/disconnect the planet carrier 624 and ring gear 620 in the opposite direction of rotation, for example, counterclockwise. The second coupling assembly or mechanism 636 includes a pocket plate 660, and a notch plate 662. The pocket plate 660 is connected to the ring gear 620 and the notch plate 662 is connected to the planet carrier plate 625 and ultimately to the planet carrier 624/output shaft 614. The locking elements 656, 658 associated with the second coupling assembly or mechanism 636 are located in the pocket plate 660. The second coupling assembly or mechanism 636 selectively couples or connects the ring gear 620 to the planet carrier 624. The controllable one-way clutches or coupling assemblies 652, 654 of the second coupling assembly or mechanism 636 act between two rotating components; they rotate together, for example, between the planet carrier 624 and the ring gear 620, producing a direct drive or 1:1 ratio between the input or first shaft 612 and the output or second shaft 614. Other examples of producing a direct drive include coupling the sun gear 618 and the ring gear 620 or the sun gear 618 and the planet carrier 624. In one example, the locking elements 656, 644 are locking elements that “ratchet” or operate in a “ratchet” state and may be referred to as ratcheting locking elements.

In one example, the first and second coupling assemblies or mechanisms 634, 636 include an actuator in the form of a linear motor or linear actuator, generally seen at 664. The actuator 664 includes a stator 666 and a translator 668. For example, the stator 666 is fixed in position to a housing (not shown). The stator 666 includes induction coils 670 housed between steel plates 672.

The translator 668 includes an annular ring of segmented permanent magnets 674 and steel plates 676. The translator 668 connects to and rotates with the member 621 connected to the ring gear 620 and moves linearly between lateral, axial positions. The linear actuator 664 actively controls an operating mode of the shift system by generating an electromagnetic force with the stator 666 that interacts with the translator 668, causing the translator 668 to slide, move back and forth, axially on the member 621 connected to the ring gear 620.

The actuator 664 is operative to move the respective locking elements 644, 656, 658 between an engaged/deployed position and a disengaged/nondeployed position. In one example, the translator 668 includes a first radially extending actuation or spring plate 682 associated with the 1^{st} and a second radially extending actuation or spring plate 684 associated with the 2^{nd} gear ratio, torque reduction path 630. The first spring plate 682 acts on an actuation member, shown as a spring 686B, and the second spring plate 684 acts on actuation members, shown as springs 688A, 688B. In one example, the springs 686B, 688A, 688B are coiled springs received within the respective passageways 690B, 692A, 692B to provide an actuating force to move the locking elements 644, 656, 658 between their engaged, deployed, and disengaged, nondeployed positions. A bias member or spring 694A in an inner recess or blind bore 695A continuously acts on the locking element 642 to bias it out of the pocket 648A of the pocket plate 648 to an engaged or deployed position.

Pocket 648B has an inner recess or blind bore 695B for receiving biasing member or spring 694B. The pockets 660A, 660B each have an inner recess 697A, 697B for receiving biasing members or springs 696A, 696B. The biasing members or springs 694A, 694B, 696A, 696B are located under the respective locking elements 642, 644, 656, 658 and continuously act on the respective locking elements 642, 644, 656, 658 to bias, or urge them outward to a deployed position.

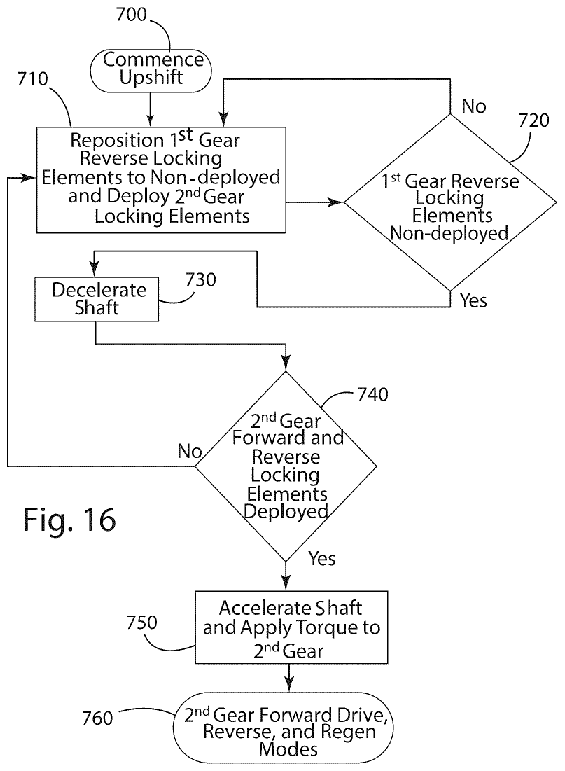

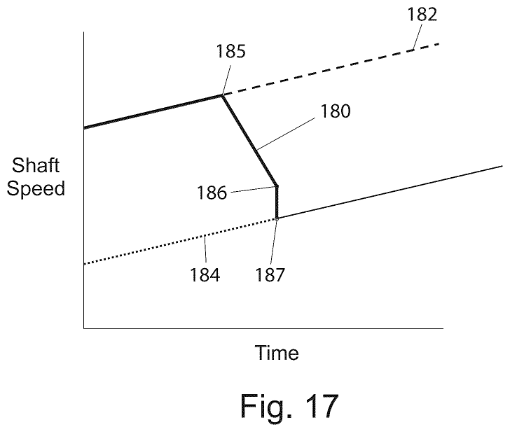

FIG. 16 is a flowchart illustrating one example of the inventive system and method of the power transmission system or assembly showing an upshift from 1^{st} gear to 2^{nd} gear, wherein the power transmission system or assembly 610 shifts from 1^{st} gear forward propulsive torque to 2^{nd} gear forward propulsive torque. FIG. 17 is a speed over time diagram illustrating relative shaft speeds. The drawing schematically illustrates the speed, solid line 180, of the input—the first shaft 612 and sun gear 618; the input speed, dashed line 182, of the 1^{st} gear ratio—the speed of the input or first shaft 612 and sun gear 618 resulting in a particular or known output speed at the output or second shaft 614; and the input speed, dotted line 184, of the 2^{nd} gear ratio—the speed of the input or first shaft 612 and sun gear 618 resulting in a particular or known output speed at the output or second shaft 614. A change in the input speed 180 of the sun gear 618 results in a corresponding change in the speed at the output member or second shaft 614 in the 1^{st} gear ratio. When the ring gear 620 is coupled to ground 632 and the output is through the planet carrier 624—the gear ratio may change, a certain input provides a certain output. A change in the input speed 180 of the sun gear 618 results in a corresponding change in the speed at the output member or second shaft 614 in the 2^{nd} gear ratio. When the ring gear 620 is coupled to the planet carrier 624 and the output is through the planet carrier 624 a certain input provides a certain output. Because the speed of the output or second shaft 614 is known, or can be measured, the respective input speeds 182, 184 of the of the 1^{st} and 2^{nd} gear ratios can be known through calculation.

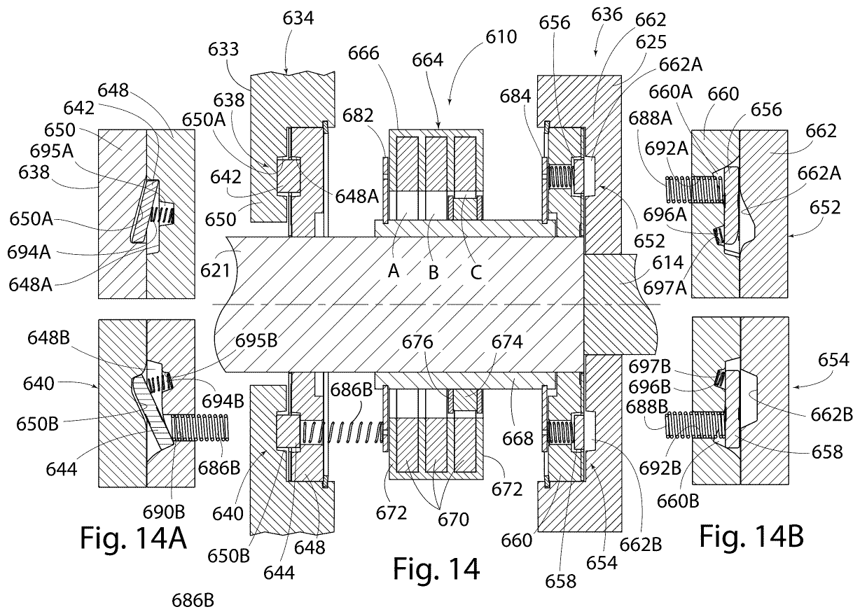

FIG. 16 shows the method begins in step 700 with a signal or command to commence an upshift from 1^{st} gear forward to 2^{nd} gear forward. Initially, the actuator 664 is in the third position—Position C, associated with the far-right set of induction coils 670 of the actuator 664, see FIGS. 14-14B. The passive one-way clutch or coupling assembly 638, including the forward torque transmitting locking element 642, and the controllable one-way clutch or coupling assembly 640, including the reverse torque transmitting locking element 644, are deployed. Each extends outward from its respective pocket 648A, 648B of the pocket plate 648. The locking elements 642, 644 couple the ring gear 620 to ground 632 and may either transfer forward, reverse, and regenerative torque. The locking elements 656, 658 of the controllable one-way clutches or coupling assemblies 652, 654 of the second coupling assembly or mechanism 636 are nondeployed. Each locking element 656, 658 remains in its respective pocket 660A, 660B. The locking elements 656, 658 transfer no torque from the first shaft 612 or sun gear 618 through the ring gear 620 and planet carrier 624 combination, the 2^{nd} gear ratio. Because the locking element 642 is deployed, it couples the ring gear 620 and ground 632 in the forward direction. In FIG. 17, the speed 180 of the input or first shaft 612 and sun gear 618 rotates the planet carrier 624 at a relative speed, for example, a 3:1 ratio. While the speeds 180, 182 are shown coincident, this is for illustrative purposes only. A predetermined or particular input speed 180 results in a predetermined or particular output speed at the output or second shaft 614. The solid and dashed lines are coincident because the propulsive torque is in the forward direction through the locking element 642.

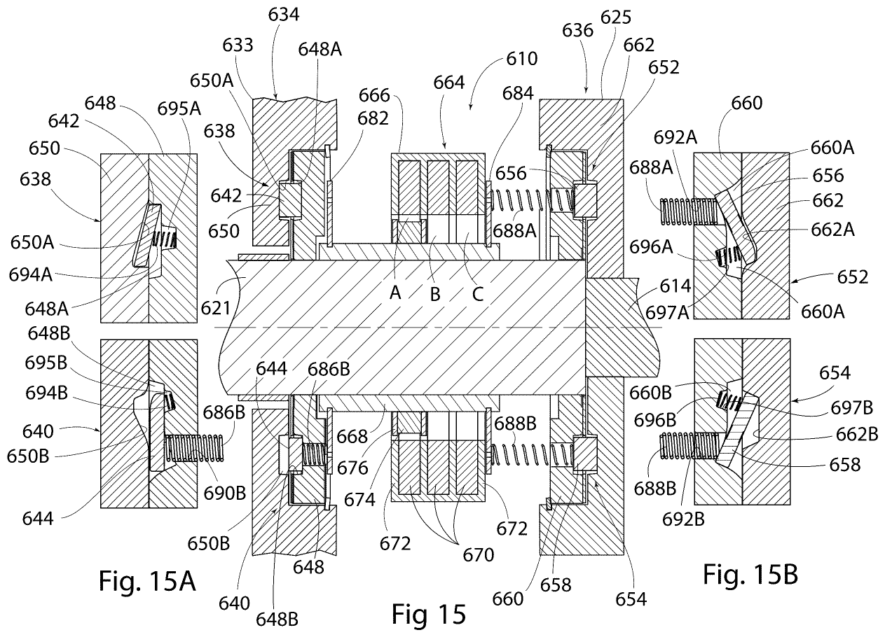

In Step 710, in preparation for the shift, the actuator moves to the first position—Position A, associated with the far-left set of induction coils 670 of the linear actuator 664, see FIGS. 15-15B. The actuator 664 acts to reposition the locking elements 644 associated with reverse torque of the 1^{st} gear ratio from the deployed position to a nondeployed position and deploys the locking elements 656, 658 of the 2^{nd} gear ratio. As the shift assembly prepares for the power on upshift from the 1^{st} gear ratio to the 2^{nd} gear ratio, the locking element 644 of the controllable one-way clutch or coupling assembly 640 associated with the reverse torque is disengaged or nondeployed, placed in the pocket 648B of the pocket plate 648. The passive one-way clutch or coupling assembly 638 remains on and transfers torque in the forward direction, while the controllable one-way clutch or coupling assembly 640 is turned off, wherein no torque is transferred in the reverse or regenerative direction.

In Step 720, if desired, the method determines if the locking elements 644 are nondeployed. If not nondeployed, the method returns to step 710. If the locking elements 644 are disengaged or nondeployed, the method proceeds to step 730. Whether the locking elements 644 are disengaged or nondeployed may be determined by speed, position, and torque sensors that monitor the respective parameters of the components.

In step 730 the system decelerates the speed of the first shaft 612 and sun gear 618. This step may occur prior to deploying the locking elements 656, 658 of the 2^{nd} gear ratio. The steps may take place in no particular order. In one example, instead of prior to the deceleration of the first shaft 612 and sun gear 618, the locking elements 656, 658 of the controllable one-way clutches or coupling assemblies 652, 654 are deployed at the start or during the deceleration of the first shaft 612 and sun gear 618. Deployment of the locking elements 656, 658 associated with the 2^{nd} gear ratio may occur before, during, or after initially decelerating the speed of the first shaft 612 and sun gear 618.

The forward locking element 656 may be deployed without engaging a notch 662A in the corresponding notch plate 662 because the locking element 656 ratchets. The relative rotational motion between the locking element 656 and the notch plate 662 is above the predetermined window of rotational speed such that the locking element 656 is unable to or cannot move deep enough into the notch 662A to engage and stop relative rotational motion between the pocket plate 660 and the notch plate 662. Instead of engaging the notch 662A, the locking element 656 skips out of the notch 662A allowing continued relative motion. The locking element 658 may be deployed without engaging a corresponding notch 662B in the notch plate 662 because the locking element 658 overruns.

FIG. 17 shows the speed 180 of the input member or first shaft 612 decelerating and diverging at point 185 from the input speed 182 of the 1^{st} gear ratio. While the speed 180 of the first shaft 612 and sun gear 618 continues to decelerate, a vehicle propulsion mechanism connected to the output member or second shaft 614, for example, the vehicle wheels, rotates the output or second shaft 614. As the vehicle continues in a forward direction, the output or second shaft 614 and the planet carrier 624 continue to rotate. The rotation rate of the planet carrier 624 gradually slows as vehicle drag, friction, and other elements act on the vehicle. In one example of the present system, the input member or first shaft 612 is coupled to and driven by an electric motor. With an electric motor, the motor speed can be reduced rapidly. For example, the motor speed, and correspondingly the speed 180 of the input member or first shaft 612, may go from 2000 to 1500 RPM in less than a second.

Because the input shaft 612 is connected to the motor, the input speed 180 of the input shaft 612 may rotate slower than the input speed 182 of the 1^{st} gear ratio, determined by the speed of the output or second shaft 614—connected to the planet carrier 624. As the first shaft 612 slows, the planets 622 of the planet carrier 624 cause the ring gear 620 to rotate, and the first locking element 642 of the controllable one-way clutch or coupling assembly 638 overruns. When in the disengaged or nondeployed position, the locking element 644 no longer holds torque, wherein the ring gear 620 rotates in the same direction as the sun gear 618.

Because the ring gear 620 is initially at a non-rotational speed, the planet carrier 624 is rotating faster than the ring gear 620. For example, the ring gear 620 and associated pocket plate 660 and the deployed locking element 656, are initially stationary while the planet carrier 624, connected to the output member or second shaft 614 and the associated notch plate 662 rotates. Reducing or dropping the input speed 180 or speed of the first shaft 612 and sun gear 618 sun accelerates the speed of the ring gear 620 towards the speed 184 of the 2^{nd} gear ratio, the second shaft 614 and planet carrier 624. Because the ring gear 620 is rotating slower but in the same direction as the planet carrier 624, the pocket plate 660 associated with the ring gear 620 rotates slower than the notch plate 662 associated with the planet carrier 624. The forward torque transmitting element 656, ratchets, is in a ratcheting condition or state. Instead of engaging, the deployed locking element 656 skips out of, or passes over, the notch 662A in the notch plate 662, connected to or part of the planet carrier 624, and transfers no torque from the first shaft 612 to the ring gear 620. The deployed reverse torque transmitting element 658 is in an overrun condition or state and transfers no torque from the first shaft 612.

FIG. 17 shows the ratcheting condition or state of the locking element 656 continuing as the speed 180 of the first shaft 612 decelerates until the speed of the first shaft 612 reaches point 186 where the deployed locking element 656 exits the ratcheting condition or state and engages the notch 662A in the notch plate 662 connected to or part of the planet carrier 624. Point 186 at which the deployed locking element 656 no longer ratchets and engages a corresponding notch 662A in the notch plate 662 occurs at a predetermined window of rotational speed between the speed 180 of the input or first shaft 612 and the speed 184 of the 2^{nd} gear ratio. In one example, a predetermined window of rotational speed is a rotational speed difference between components of 200 RPM or less. In another example, the rotational speed difference may be between 50 RPM and 100 RPM. In a further example, the rotational speed difference is at or below 50 RPM. While shown as a point 186, this is for illustration only as point 186 typically encompasses a range.

When the locking element 656 engages the notch plate 662 portion of the planet carrier 624, at point 186, the ring gear 620 speed rapidly increases to the speed 180 of the first shaft 612 and sun gear 618. Because the speed 184 of the 2^{nd} gear assembly, prior to engagement of the locking element 656 is initially controlled by the inertia of the system, the speed of the ring gear 620 increases once the locking element 656 engages, after which the motor speed reduces to the speed of the planet carrier 624 and ring gear 620 combination. In some instances, there may be a slight blip or change in speed of the motor speed or sun gear 618 once the locking element 656 engages.

Although the locking elements 656, 658 of the controllable one-way clutches or coupling assemblies 652, 654 of the second coupling assembly or mechanism 636 are deployed and at point 186 engage respective notches 662A, 662B in the notch plate 662, connected to or part of the planet carrier 624 no torque, or at best minimal torque, is transmitted from the first shaft 612 to the planet carrier 624/ring gear 620 combination upon initial deployment during a power on upshift from 1^{st} gear to 2^{nd} gear. FIG. 17 shows the speed 180 of the first shaft 612 decreasing from point 186 to point 187 wherein the speed 180 of the first shaft 612 synchronizes with the input speed of the 2^{nd} gear ratio. Synchronize means relative rotating components are rotating within a predetermined window of rotational speed. In one example, a predetermined window of rotational speed is a difference of ±100 RPM. While identified as points 185, 186, 187, they may not be discrete points but encompass a range.

The ratcheting speed, or speed at which the locking element 656 no longer ratchets but engages at point 186, the difference in relative rotational motion between the speed of the ring gear 620 and the speed of the planet carrier 624 or second shaft 614 are withing the predetermined window of rotational speed, to provide a smooth transition or shift and/or remove or reduce the occurrence of jerk or a perceived harsh shift. For example, the smaller the difference in relative rotational motion, or the speed at which the ratcheting locking element 656 engages the notch 662A, the smoother the shift or reduced occurrence of jerk. After engagement of the locking element 656, the speed 180 of the input or first shaft 612 continues to decrease from the engagement point 186 to the synchronization point 187. Because the locking element 656 is already engaged at the synchronization point 187, propulsion torque can be applied to the first shaft 612, which is then transferred from the sun gear 618 to the planet carrier 624/ring gear 620 combination and ultimately the output or second shaft 614 connected to the planet carrier 624 with a minimal a transition period or curve, without the need for fine motor control to gradually slow the speed 180 of the input or first shaft 612 to increase and match the speed of the ring gear 620 with the planet carrier 624.

In step 740, if desired, the method determines if the locking elements 656, 658 associated with the 2^{nd} gear ratio are deployed. If not deployed, the method returns to step 710. If the locking elements are deployed, the method proceeds to step 750. Whether the locking elements 656, 658 are engaged or deployed may be determined by speed, position, and torque sensors that monitor the respective parameters of the components.

In step 750 the system or assembly 610 accelerates the input or first shaft 612, transfers torque through the coupled planetary carrier 624 and ring gear 620, and provides torque through the 2^{nd} gear ratio. In FIG. 17, the respective speeds 180, 184 of the input or first shaft 612 and the input of the 2^{nd} gear ratio are equal because the propulsive torque is in the forward direction through the locking element 656. The solid and dotted lines 180, 184 are coincident as the sun gear 618, ring gear 620 and planet carrier 624 all rotate together at the same speed.

In step 760, once coupled, the controllable one-way clutches or coupling assemblies 652, 654 of the second coupling assembly or mechanism 636 transfer torque from the motor through the input or first shaft 612, the 2^{nd} gear ratio, and the output or second shaft 614 to the vehicle propulsion mechanism, for example, the vehicle wheel. The system operates in the 2^{nd} gear ratio in forward, reverse, and regeneration modes.

FIGS. 16 and 17 illustrate an upshift from 1^{st} gear to 2^{nd} gear for forward propulsion torque. The passive one-way clutch or coupling assembly 638 and the controllable one-way clutch or coupling assembly 640 of the first coupling assembly or mechanism 634 are both in an engaged or deployed position. In preparing to shift, while still in the 1^{st} gear node, the passive one-way clutch or coupling assembly 638 remains in an engaged position, and the controllable one-way or coupling assembly 640 is placed in a disengaged or nondeployed position, the controllable one-way clutch or coupling assembly 640 is off. After the coupling assembly 640 is nondeployed, or while the coupling assembly 640 is moving to a nondeployed position, the controllable one-way clutches or coupling assemblies 652, 654 of the second coupling assembly or mechanism 636 are moved to a deployed position wherein the locking element 656 of the controllable one-way clutch or coupling assembly 652 ratchets and the locking element 658 of the controllable clutch or coupling assembly 654 overruns. Engagement of the locking element 656 occurs based on the vehicle speed and the motor speed. In the 2^{nd} gear node, the controllable one-way clutches or coupling assemblies 652, 654 are in an engaged or deployed position with the first coupling assembly or mechanism 638 in a deployed position and the controllable one-way clutch or coupling assembly 640 in a disengaged or nondeployed position, the controllable one-way clutch or coupling assembly 640 is off.

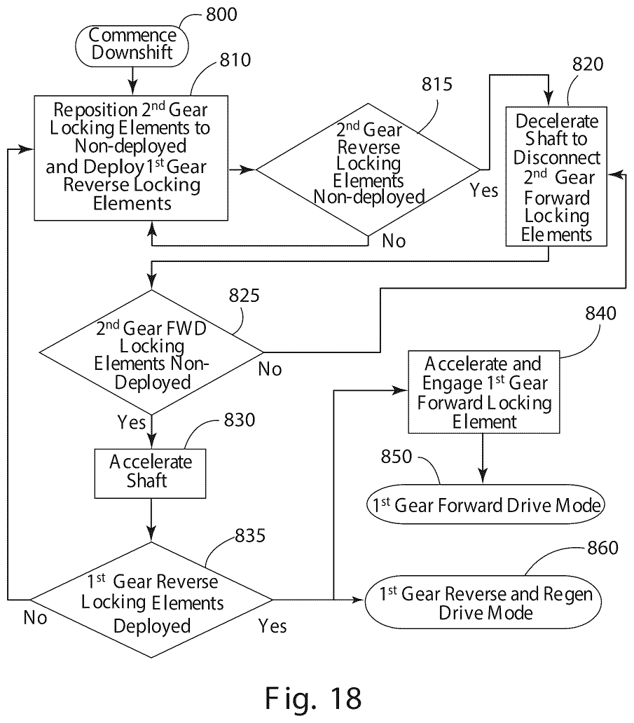

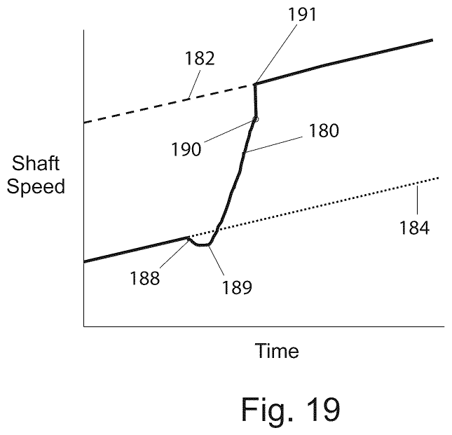

FIG. 18 is a flowchart of one example of the inventive system and method showing a downshift from 2^{nd} gear to 1^{st} gear, wherein the power transmission system or assembly 610 shifts from 2^{nd} gear forward propulsive torque to 1^{st} gear forward propulsive torque. FIG. 19 is a speed over time diagram illustrating relative shaft and gear speeds. The drawing schematically illustrates the speed, solid line 180, of the input—the first shaft 612 and sun gear 618; the input speed, dashed line 182, of the 1^{st} gear ratio—the speed of the input or first shaft 612 and sun gear 618 resulting in a particular or known output speed at the output or second shaft 614; and the input speed, dotted line 184, of the 2^{nd} gear ratio—the speed of the input or first shaft 612 and sun gear 618 resulting in a particular or known output speed at the output or second shaft 614. A change in the input speed 180 of the sun gear 618 results in a corresponding change in the speed at the output member or second shaft 614 in the 1^{st} gear ratio. When the ring gear 620 is coupled to ground 632, and the output is through the planet carrier 624—the gear ratio may change, a certain input provides a certain output. A change in the input speed 180 of the sun gear 618 results in a corresponding change in the speed at the output member or second shaft 614 in the 2^{nd} gear ratio when the ring gear 620 is coupled to the planet carrier 624, and the output is through the planet carrier 624—a certain input provides a certain output. Because the speed of the output or second shaft 614 is known or can be measured, the respective input speeds 182, 184 of the of the 1^{st} and 2^{nd} gear ratios can be known through calculation.

FIG. 18 shows the method begins in step 800 with a signal or command to commence a downshift from 2^{nd} gear forward to 1^{st} gear forward. Initially, the actuator 664 is in the first position—Position A, associated with the far-left set of induction coils 670 of the actuator 664. The locking elements 656, 658 of the controllable one-way clutches or coupling assemblies 652, 654 of the second coupling assembly or mechanism 636 are deployed. Each extends outward from its respective pocket 660A, 660B of the pocket plate 660. The locking elements 656, 658 of the second coupling assembly or mechanism 636 couple the ring gear 620 to the planet carrier 624 and may either transfer forward, reverse, and regenerative torque. The locking elements 644 of the first coupling assembly or mechanism 634 are nondeployed. The locking elements 644 remain in the respective pockets 648B. The locking elements 644 react no torque from the input or first shaft 612 through ring gear 620 and ground 632 combination, the 1^{st} gear ratio. Because the locking element 656 is deployed, it couples the ring gear 620 and planet carrier 624 in the forward direction. In FIG. 19, the speed 180 of the input or first shaft 612 and sun gear 618 rotates the planet carrier 624 at a relative speed, for example, a 1:1 ratio. While the speeds 180, 184 are shown coincident, this is for illustrative purposes only, wherein a predetermined or particular input speed 180 results in a predetermined or particular output speed at the output or second shaft 614, coupled to the planet carrier 624. The solid and dashed lines are coincident because the propulsive torque is in the forward direction through the locking element 656.

In step 810, as the shift assembly prepares for the power on downshift from the 2^{nd} gear ratio to the 1^{st} gear ratio, the actuator 664 moves to the third position—Position C and repositions the locking elements 656, 658 of the controllable one-way clutches or coupling assemblies 652, 654 of the second coupling assembly or mechanism 636 in a nondeployed position and deploys the 1^{st} gear reverse locking elements 644 of the controllable one-way clutch or coupling assembly 640 of the first coupling assembly or mechanism 634. Because the locking element 656 is still carrying forward torque, it may remain in a deployed position and still engaged.

The 1^{st} gear reverse locking element 644 may be deployed without engaging a notch 650B in the corresponding notch plate 650 because the locking element 644 ratchets. The relative rotational movement between the locking element 644 and the stationary notch plate 650 is above the predetermined window of rotational speed such that the locking element 644 is unable to or cannot move deep enough into the notch 650B to engage and stop relative rotational motion between the pocket plate 648 and the notch plate 650. Instead of engaging the notch 650B, the locking element 644 ratchets, skips out of the notch 650B, allowing continued relative motion. The forward locking element 642 does not engage a corresponding notch 650A because the locking element 642 overruns. In the present example, the 1^{st} gear reverse locking element 644 is capable of both ratcheting and overrunning.

In Step 815, if desired, the method determines if the locking elements 658 are nondeployed. If not nondeployed, the method returns to step 810. If the locking elements 658 are nondeployed, the method proceeds to step 820. Whether the locking elements 658 are disengaged or nondeployed may be determined by speed, position, and torque sensors that monitor the respective parameters of the components.

In step 820 the system decelerates the speed 180 of the input or first shaft 612 and sun gear 618 to remove torque and reposition the forward locking elements 656 to a nondeployed position. FIG. 19 shows the speed 180 of the input or first shaft 612 diverges, falls below the input speed 184 of the 2^{nd} gear ratio starting at point 188. Decreasing the speed 180 of the input or first shaft 612 and sun gear 618 below that of the input speed 184 of the 2^{nd} gear ratio removes the torque on the locking element 656, allowing disengagement, the force of the actuation member or spring 688A acts on the locking element 656 moving it to the nondeployed position.

Step 825 determines if the locking elements 656 are nondeployed. If not nondeployed, the method returns to step 810. If the locking elements 656 are nondeployed, the method proceeds to step 830. Whether the locking elements 656 are disengaged or nondeployed may be determined by speed, position, and torque sensors that monitor the respective parameters of the components.

Step 830 accelerates the speed 180 of the input or first shaft 612. As shown in FIG. 19, the speed 180 of the input or first shaft 612 accelerates from a low point 189 and passes the input speed 184 of the 2^{nd} gear ratio. Because the planetary carrier 624 is rotating at the output speed of the output or second shaft 614, based on, for example, the vehicle wheel speed, it remains relatively constant during the shift.

In step 835, if desired, the method determines if the locking elements 644 are engaged or deployed. If not deployed, the method returns to step 810. If the locking elements 644 are engaged or deployed, the method proceeds to step 840 and step 860. Whether the locking elements 644 are engaged or deployed may be determined by speed, position, and torque sensors that monitor the respective parameters of the components.

Referring to FIG. 19, as the speed 180 of the input or first shaft 612 increases and approaches the input speed 182 of the 1^{st} gear ratio the speed of the ring gear 620 slows. The speed of the ring gear 620 and that of the locking elements 644 slow until reaching a relative rotational speed between the ring gear 620 and ground 632, within the predetermined window of rotational speed. For example, at point 190 the rotational speed of the ring gear 620 relative to ground 632, when one component is stationary and the other is rotating, is within the predetermined window of rotational speed, wherein the locking element 644 of the controllable one-way clutch or coupling assembly 640 of the first coupling assembly or mechanism 634 engages the notch 650B in the notch plate 650 connected to ground 632. When the speed of the ring gear 620 reaches or falls within the predetermined window of rotational speed, the locking element 644 stops ratcheting and engages, coupling the ring gear 620 to ground 632 and holding the ring gear 620 stationary.

The difference in relative rotational motion between the ground 632 and the speed of the ring gear 620 is predetermined to provide a smooth transition, removing or reducing the occurrence of jerk or a perceived harsh shift.

After engagement of the locking element 644, the speed 180 of the input or first shaft 612 increases from the engagement point 190 to the synchronization point 191. Because the locking element 644 engages at engagement point 190 the speed 180 of the input or first shaft 612 rapidly increases and the input speed 182 of the 1^{st} gear ratio speed rapidly synchronizes with the speed 180 of the input or first shaft 612. There may be a slight blip or decrease in the input speed 182 of the 1^{st} gear ratio as the respective speeds 180 and 182 synchronize. The locking element 642 of the one-way clutch or coupling assembly 638 stops overrunning and engages, connects, and begins to react torque as the speed 180 of the input or first shaft 612 increases, wherein the speeds 180, 182 are the same, the solid and dashed lines are coincident because the propulsive torque is in the forward direction through the locking element 642.

Using the ratchet locking element 644 reduces the need to gradually reduce the acceleration of the speed 180 of the input or first shaft 612 as it reaches a speed necessary to synchronize the speed of the ring gear 620 and ground 632 to achieve a smooth shift. Whereby the motor speed, and corresponding speed 180 of the input or first shaft 612, may be increased without the need for a transition period or curve, use of fine motor control to gradually increase the speed 180 of the input or first shaft 612, to match the respective speeds 180, 182 and reduce a jerk or harsh shift. The synchronization takes place based on engagement of the first gear reverse locking element 644, after which the locking element 642 of the one-way clutch or coupling assembly 638 stops overrunning and engages, connects, and begins to transfer torque. The speed 180, 182 of the input or first shaft 612 and the output or second shaft 614 are proportional, and the solid and dashed lines are coincident because the propulsive torque is in the forward direction through the locking element 642. Using the ratchet locking element 644 synchronizes the speed 180 of the input or first shaft 612 and sun gear 618 with the speed 182 of the 1^{st} gear ratio to achieve a smooth shift. The synchronization takes place based on engagement of the first gear reverse locking element 644.

In step 840 the first one-way clutch or coupling assembly 638 engages, connects, and begins to transfer torque, and the solid and dashed lines are coincident because the propulsive torque is in the forward direction through the locking element 642. The system provides forward torque and propulsion through the 1^{st} gear ratio in the forward mode. FIG. 19 shows the speed 180 of the input or first shaft 612 the same as the input speed 182 of the 1^{st} gear ratio wherein the lines 180, 182 are coincident.

In steps 850 and 860 the system operates in 1^{st} gear, the 1^{st} gear ratio, in forward, reverse, and regeneration modes. In the regeneration mode the system provides regeneration torque—regenerative braking.

FIGS. 18 and 19 illustrate a downshift from 2^{nd} gear to 1^{st} gear in forward propulsive torque. Initially, the system moves the locking elements 644 of the first coupling assembly or mechanism 636 to a deployed position and moves the locking elements 656, 658 of the second coupling assembly or mechanism 636 to a nondeployed position. However, the locking element 656 of the second coupling assembly or mechanism 636 associated with forward torque remains in an engaged or deployed position, extending from the pocket 660A due to forward torque. The locking element 658, associated with reverse and regenerative torque, is disengaged or nondeployed, is placed in, and remains in the pocket 660B of the pocket plate 660. The locking element 644, while deployed, ratchets and does not engage the notch 650B in the notch plate 650 attached to ground 632. The locking element 642, while deployed, overruns and does not engage the notch 650A in the notch plate 650 attached to ground 632. The shift continues by initially decelerating the motor to remove forward torque on the locking element 656 and then accelerating the speed 180 of the input or first shaft 612. The motor increases the rotational speed 180 of the input or first shaft 612 until the ring gear 620 and the locking element 644 reach or are within the predetermined window of rotational speed at which point the locking element 644 no longer ratchets, it engages a notch 650B in the notch plate 650 connected to ground 632, wherein the ring gear 620 stops rotating. Once the ring gear 620 stops rotating, the forward locking element 642 stops overrunning and engages the ring gear 620. The locking element 642 of the controllable one-way clutch or coupling assembly 640 transmits forward torque from the input or first shaft 612 and, correspondingly, the motor output to the second shaft 614 through the 1^{st} gear ratio.

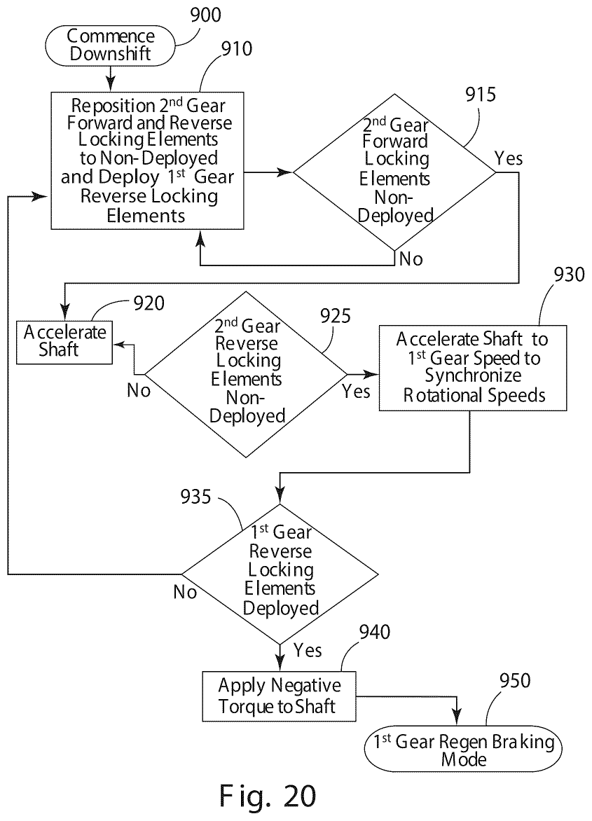

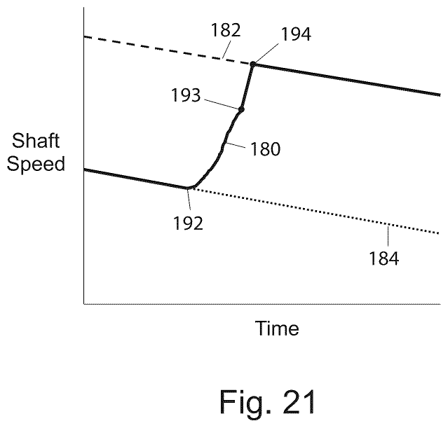

Referring to the drawings, FIG. 20 is a flowchart of one example of the inventive system and method showing a downshift from 2^{nd} gear to 1^{st} gear, wherein the power transmission system or assembly 610 downshifts from 2^{nd} regenerative torque—regenerative braking to 1^{st} gear regenerative torque—regenerative braking. FIG. 21 is a speed over time diagram illustrating relative shaft and gear speeds. The drawing schematically illustrates the speed, solid line 180, of the input—the first shaft 612 and sun gear 618; the input speed, dashed line 182, of the 1^{st} gear ratio—the speed of the input or first shaft 612 and sun gear 618 resulting in a particular or known output speed at the output or second shaft 614; and the input speed, dotted line 184, of the 2^{nd} gear ratio—the speed of the input or first shaft 612 and sun gear 618 resulting in a particular or known output speed at the output or second shaft 614. A change in the input speed 180 of the sun gear 618 results in a corresponding change in the speed at the output member or second shaft 614 in the 1^{st} gear ratio. When the ring gear 620 is coupled to ground 632, and the output is through the planet carrier 624—the gear ratio may change, a certain input provides a certain output. A change in the input speed 180 of the sun gear 618 results in a corresponding change in the speed at the output member or second shaft 614 in the 2^{nd} gear ratio when the ring gear 620 is coupled to the planet carrier 624 and the output is through the planet carrier 624, a certain input provides a certain output. Because the speed of the output or second shaft 614 is known or can be measured, the respective input speeds 182, 184 of the of the 1^{st} and 2^{nd} gear ratios can be known through calculation.

FIG. 20 shows the method begins in step 900 with a signal or command to commence a downshift from 2^{nd} gear regenerative torque—regenerative braking to 1^{st} gear regenerative torque—regenerative braking. Initially, the actuator 664 is in the first position—Position A. The locking elements 656, 658 of the controllable one-way clutches or coupling assemblies 652, 654 of the second coupling assembly or mechanism 636 are deployed and may transfer either forward or regenerative torque. As shown in FIG. 21, because the locking elements 656, 658 are deployed, the speed 180 of the input or first shaft 612 and the sun gear 618 and the input speed 184 of the 2^{nd} gear ratio are the same, the solid line and dotted lines are coincident because the regenerative torque is in the forward direction through the locking element 658.

In step 910, in preparation for the shift, the actuator moves to the third position—Position C. The locking elements 656, 658 are repositioned from the initial deployed position to a nondeployed position. The locking elements 644 of the controllable one-way clutch or coupling assembly 640 of the first coupling assembly or mechanism 634 are deployed. The locking elements 642 of the passive one-way clutch or coupling assembly 638 of the second coupling assembly or mechanism 634 remain deployed. Because of the speed differential between the ring gear 620 and ground 632, the locking elements 644 ratchet and do not engage and the locking elements 642 overrun.

In step 915 the method determines if the locking elements 656 are nondeployed. If not nondeployed, the method returns to step 910. If the locking elements 656 are nondeployed, the method proceeds to step 920. Whether the locking elements 656 are disengaged or nondeployed may be determined by speed, position, and torque sensors that monitor the respective parameters of the components.

Because the reverse locking elements 658 are still carrying torque, they may remain in a deployed position and still engaged. In step 920 the system accelerates the speed 180 of the input or first shaft 612 to remove torque and reposition the locking elements 658 to a nondeployed position. FIG. 20 shows the speed 180 of the input or first shaft 612 and sun gear 618 accelerates at point 192. Wherein the speed 180 of the input or first shaft 612 and sun gear 618 and the input speed 184 of the 2^{nd} gear ratio diverge, with the speed 180 of the input or first shaft 612 and sun gear 618 increasing above the input speed 184 of the 2^{nd} gear ratio at point 192. Increasing the speed 180 of the input or first shaft 612 and sun gear 618 removes torque on the locking element 658, allowing disengagement. For example, the force of the actuation member or spring 688B acts on the locking element 658 once the torque is removed to move it to the nondeployed position.

Step 925 determines if the locking elements 658 of the second coupling assembly or mechanism 636 are nondeployed. If not nondeployed, the method returns to step 910. If the locking elements 658 are nondeployed, the method proceeds to step 930. Whether the locking elements 658 are disengaged or nondeployed may be determined by speed, position, and torque sensors that monitor the respective parameters of the components.

In Step 930 the system continues to accelerate the speed 180 of the input or first shaft 612 and sun gear 618 and correspondingly slow the speed of the ring gear 620. The locking element 644 of the first coupling assembly or mechanism 634, while deployed, ratchets and does not engage the notch plate 650 attached to ground 632. FIG. 20 shows the rotational speed 180 of the input or first shaft 612 and sun gear 618 increasing until it reaches point 193, the predetermined window of rotational speed, at which point the locking element 644 no longer ratchets and engages a notch 650B in the notch plate 650 connected to or part of ground 632. Once the locking element 644 engages, the speed 180 of input or first shaft 612 and sun gear 618 and the input speed 182 of the 1^{st} gear ratio synchronize at point 194. When engaged, the second one-way clutch or coupling assembly 640 enables torque transfer for regeneration, wherein decreasing the input speed 182 of the 1^{st} gear ratio correspondingly decreases the speed 180 of the input or first shaft 612. The solid line and dashed lines are coincident because the regenerative torque is in the forward direction through the locking element 644.

Step 935 determines if the locking elements 644 of the first coupling assembly or mechanism 634 are deployed. If not deployed, the method returns to step 910. If the locking elements 644 are deployed, the method proceeds to step 940. Whether the locking elements 644 are engaged or deployed may be determined by speed, position, and torque sensors that monitor the respective parameters of the components.

In Step 940 the system applies a negative or reverse torque to the input or first shaft 612. The negative or reverse torque resulting from output or second shaft 614 driving the 1^{st} gear ratio and, correspondingly, the input or first shaft 612. In step 950 the system operates in 1^{st} gear regeneration mode.

FIGS. 20 and 21 illustrate a downshift from 2^{nd} gear to 1^{st} gear, wherein the power transmission system or assembly 610 downshifts from 2^{nd} regenerative torque—regenerative braking to 1^{st} gear regenerative torque—regenerative braking. Initially, the locking elements 656, 658 of the controllable one-way clutches or coupling assemblies 652, 654 of the second coupling assembly or mechanism 636 are engaged and may transfer either forward or regenerative torque. As the shift assembly prepares to downshift from 2^{nd} gear to 1^{st} gear, the locking element 656 associated with forward torque is disengaged or nondeployed, is placed in, and remains in the pocket 660A of the pocket plate 660. The locking element 658, associated with reverse and regenerative torque, also moves to a disengaged or nondeployed position. However, due to torque loads it may remain in an engaged or deployed position, extending from the pocket 660B. The locking elements 644 of the controllable one-way clutch or coupling assembly 640 of the first coupling assembly or mechanism 634 are repositioned to a deployed position. The locking elements 642 of the passive one-way clutch or coupling assembly 638 overrun, and the locking elements 644 of the controllable one-way clutch or coupling assembly 640 initially ratchet. The shift continues by accelerating the input or first shaft 612 and sun gear 618 and removing the load on the locking element 658 wherein the locking element 658 moves to the disengaged or nondeployed position. Initially, the deployed locking element 644 ratchets with the notch 650A of the notch plate 650 connected to or part of ground 632 as the rotational speed of the ring gear 620 exceeds predetermined window of rotational speed relative to ground 632. The motor increases the speed 180 of the input or first shaft 612 and sun gear 618 until the locking element 644 reaches the engagement point, stops ratcheting, and engages a notch 650B in the notch plate 650 associated with ground 632 wherein the ring gear 620 and ground 632 synchronize speed, the ring gear 620 is now stationary. The locking element 644 transmits regenerative torque from the output or second shaft 614 to the input or first shaft 612 and correspondingly the motor through the 1^{st} gear ratio.

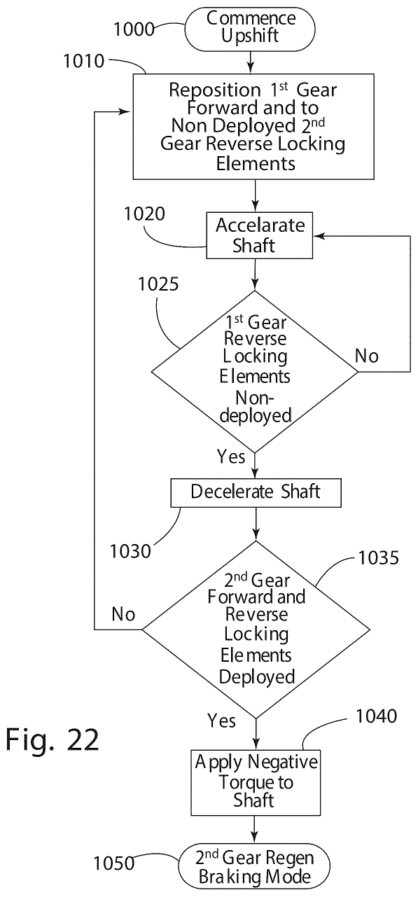

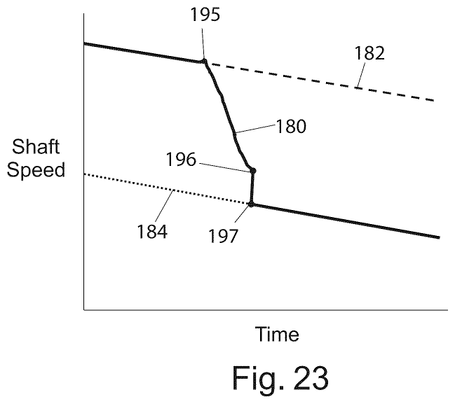

FIG. 22 is a flowchart of one example of the inventive system and method illustrating an upshift from 1^{st} gear to 2^{nd} gear, wherein the power transmission system or assembly 610 upshifts from 1^{st} gear regenerative torque—regenerative braking to 2^{nd} gear regenerative torque—regenerative braking. FIG. 23 is a speed over time diagram illustrating relative shaft and gear speeds. The drawing schematically illustrates the speed, solid line 180, of the input—the first shaft 612 and sun gear 618; the input speed, dashed line 182, of the 1^{st} gear ratio—the speed of the input or first shaft 612 and sun gear 618 resulting in a particular or known output speed at the output or second shaft 614; and the input speed, dotted line 184, of the 2^{nd} gear ratio—the speed of the input or first shaft 612 and sun gear 618 resulting in a particular or known output speed at the output or second shaft 614. A change in the input speed 180 of the sun gear 618 results in a corresponding change in the speed at the output member or second shaft 614 in the 1^{st} gear ratio. When the ring gear 620 is coupled to ground 632 and the output is through the planet carrier 624—the gear ratio may change, a certain input provides a certain output. A change in the input speed 180 of the sun gear 618 results in a corresponding change in the speed at the output member or second shaft 614 in the 2^{nd} gear ratio when the ring gear 620 is coupled to the planet carrier 624, and the output is through the planet carrier 624—a certain input provides a certain output. Because the speed of the output or second shaft 614 is known, or can be measured, the respective input speeds 182, 184 of the of the 1^{st} and 2^{nd} gear ratios can be known through calculation.

FIG. 22 shows the method begins in step 1000 with a signal or command to commence an upshift from 1^{st} gear regenerative torque—regenerative braking to 2^{nd} gear regenerative torque—regenerative braking. Initially, the actuator 664 is in the third position—Position C. The forward torque locking elements 642 of the passive one-way clutch or coupling assembly 638 and the reverse torque transmitting locking element 644 of the controllable one-way clutch or coupling assembly 640 are deployed and may either transfer forward, reverse, and regenerative torque. Because the locking elements 642, 644 are deployed, the speed 180 of the input or first shaft 612 and the speed 182 of output or second shaft 614 in the 1^{st} gear ratio are relative and remain coincident. The solid line and the dashed line are coincident because the regenerative torque is in the forward direction through the locking element 644 and the input to output ratio is based on the gear assembly.

In step 1010, in preparation for the upshift from 1^{st} to 2^{nd} gear, the actuator moves to the first position—Position A. The locking elements 644 of the controllable one-way clutch or assembly 640 associated with the 1^{st} gear ratio, torque reduction path 629, are repositioned from their initial deployed position to a nondeployed position. The locking elements 656, 658 associated with 2^{nd} gear ratio, torque reduction path 630, are deployed, with the locking elements 656 ratcheting and the locking elements 658 overrunning.

In step 1020 the system briefly accelerates the speed 180 of the input or first shaft 612 and sun gear 618. Accelerating the speed of the input or first shaft 612 and sun gear 618 removes the torque on the locking element 644. FIG. 23 shows the speed 180 of the input or first shaft 612 increased slightly, at point 195, above the input speed 182 of the 1^{st} gear ratio allowing disengagement of locking element 644. The force of the actuation member or spring 686B acts on the locking element 644 once the torque is removed to move it to a nondeployed position.

Step 1025 determines if the locking elements 644 are nondeployed. If not nondeployed, the method returns to step 1020. If the locking elements 644 are nondeployed, the method proceeds to step 1030. Whether the locking elements 644 are disengaged or nondeployed may be determined by speed, position, and torque sensors that monitor the respective parameters of the components.

Step 1030 decelerates the speed 180 of the input or first shaft 612 and sun gear 618 toward the input speed 184 of the 2^{nd} gear ratio. The deployed locking element 656 ratchets and does not engage the notch 662A in the notch plate 662 attached to the planet carrier 624 and the deployed locking element 658 overruns the notch 662B in the notch plate 662 connected to the planet carrier 624. The motor reduces the rotational speed 180 of the input or first shaft 612 until the speed of the locking element 656 and the input or first shaft are within the predetermined window of rotational speed. Slowing the rotational speed 180 of the input or first shaft 612 and sun gear 618 increases the speed of the ring gear 620 to the point that locking element 656 no longer ratchets and engages the notch plate 662 of the planet carrier 624 and synchronizes the rotational speed of the ring gear 620 and planet carrier 624.

FIG. 23 shows the speed 180 of the input or first shaft 612 decelerating toward the input speed 184 of the 2^{nd} gear ratio and reaching point 196, wherein the locking element 656 engages. Once engaged the input speed 184 of the 2^{nd} gear ratio and the speed 180 of the input or first shaft 612 quickly synchronize at point 197. Further deceleration causes the locking element 658 to couple the planet carrier 624 and ring gear 620 enabling torque transfer for regeneration. The solid line and dashed lines 180, 184 are coincident because the regenerative torque is in the forward direction through the locking element 658.

Step 1035 determines if the locking elements 656, 658 associated with the 2^{nd} gear ratio are deployed. If not deployed, the method returns to step 1010. If the locking elements are deployed, the method proceeds to step 1040. Whether the locking elements 656, 658 are engaged or deployed may be determined by speed, position, and torque sensors that monitor the respective parameters of the components.

In Step 1040 the system applies negative or reverse torque to the input or first shaft 612. The negative or reverse torque resulting from the output or second shaft 614 driving the 2^{nd} gear ratio and, correspondingly, the input or first shaft 612. In Step 1050 the system operates in 2^{nd} gear regeneration mode.

FIGS. 22 and 23 illustrate an upshift from 1^{st} gear to 2^{nd} gear, wherein the power transmission system or assembly 610 upshifts from 1^{st} gear regenerative torque—regenerative braking to 2^{nd} gear regenerative torque—regenerative braking. Initially, both locking element 642 of the passive one-way clutch or coupling assembly 638 and the locking element 644 of the controllable one-way clutch or coupling assembly 640 are engaged or deployed, extending outward from respective pockets 648A, 648B of the pocket plate 648, wherein the locking elements 642, 644 may either transfer forward torque, reverse, and regenerative torque. In preparation for the shift, the locking elements 644 associated with 2^{nd} gear reverse and regenerative torque are moved to a nondeployed, nonengaged position and the locking elements 656, 658 associated with 2^{nd} gear forward, reverse and regenerative torque are deployed, with the locking elements 656 ratcheting and the locking elements 658 overrunning. As the shift assembly prepares to upshift from the 1^{st} gear ratio gear to the 2^{nd} gear ratio, because the locking element 644 associated with the regenerative torque still carries torque it remains engaged or deployed and extends out of the pocket 648B. The shift continues by briefly accelerating the motor and, correspondingly, the input or first shaft 612. As the motor speed increases the torque on the locking element 644 reduces allowing it to move to the nondeployed position. The motor then decreases the rotational speed 180 of the input or first shaft 612 until it reaches the engagement point of the locking element 656, the relative input speeds 180, 184 of the input or first shaft 612 and sun gear 618 and the input speed 184 of the 2^{nd} gear ratio are such that the locking element 656 engages the notch plate 662 associated with the planet carrier 624 and synchronizes the speed of the ring gear 620 and the planet carrier 624 wherein the speed 180 of the input or first shaft 612 and sun gear 618 and the input speed 184 of the 2^{nd} gear ratio are synchronized. After further deceleration the locking element 658 engages a notch 662B in the notch plate 662 and transmits regenerative torque from the output or second shaft 614 through the 2^{nd} gear ratio to the input or first shaft 612 and the motor. The controllable one-way clutches or coupling assemblies 652, 654 of the second coupling assembly or mechanism 636 are engaged or deployed and may either transfer forward, regenerative, and reverse torque using the 2^{nd} gear ratio.

Utilizing the ratcheting locking elements 644, 656 provides a system and method enabling a decrease in shift time. The ratcheting locking elements 644, 656 ratchet in an engagement direction. The locking elements ratchet above a predetermined window of rotational speed of adjacent components, for example a notch plate and a pocket plate. The motor slows the input or first shaft 612. Once the motor slows the input or first shaft 612, for example, when relative components are within the predetermined window of rotational speed, the respective ratcheting locking element 644, 656 engages and synchronizes the rotation of relative components. Using ratcheting locking elements 644, 656 decreases shift time because it eliminates the need to wait for motor speed to match the speed of rotation of relative components before deploying the locking element.

In the foregoing example, the locking elements 30A, 642 of the power transmission system or assemblies 10, 610 are passive, continuously deployed, and are part of the first coupling assemblies or mechanisms 21, 634. However, the first coupling assemblies or mechanisms 21, 634 may instead include a controllable one-way clutch, including a controllable locking element, similar to the controllable locking elements 30B, 644 used in coupling assemblies 23, 640. The torque carrying or locking elements of either example could be any combination of apply on or apply off, normally engaging or disengaging, and actively controlled or passive.

In addition, the actuators 40, 664 of both examples are illustrated as three position actuators. Each actuator 40, 664 has three positions A, B, and C. The foregoing examples, use only two of the positions, position A and position C. It should be understood that position B can also be used to vary the modes. For example, position B may be a neutral position or some other mode. The actuators may be multiple position actuators having, for example, three, four, and five positions. Multiple position actuators provide multiple modes of engagement.

The first coupling assembly or mechanism 634 may have a 0/1 or 1/1 mode of engagement for the ring gear 620 to ground 632 depending on the actuator position. Wherein 0 means the strut or locking element is nondeployed and 1 means the strut or locking element is deployed. In one example, 0/1 indicates that locking element 644 is nondeployed and locking element 642 is deployed and 1/1 indicates that both locking elements 644, 642 are deployed. As shown, the actuator 664 controls the first coupling assembly or mechanism 634 and the second coupling assembly or mechanism 636. Similar to the first coupling assembly or mechanism 634, the second coupling assembly or mechanism 636 may also have multiple modes, for example, 0/0 and 1/1 modes. The modes used or needed could be different and/or have more or less modes, for example up to 4 modes for the first coupling assembly or mechanism 634 and up to 4 modes for the second coupling assembly or mechanism 636.

For purposes of this application, the term “coupling assembly” should be interpreted to include clutches or brakes. It also includes coupling assemblies wherein one of the plates is drivably connected to a torque delivery element of a transmission, engine, or motor, and the other plate is connected to another torque delivery element or grounded in the case of a brake. For example, first coupling assembly or mechanism 634 may include a controllable mechanical diode clutch (CMD), which refers to a controllable or selectable one-way clutch acting between a stationary and a rotating component; for example, one race is stationary, and one is rotatable. The second coupling assembly or mechanism 636 may include a dynamically controllable clutch (DCC), which refers to a controllable or selectable one-way clutch acting between two rotating components; for example, both races rotate.

The first and second coupling assemblies or mechanisms 634, 636 may operate independently. For example, each may have its own actuation system. While the first coupling assembly or mechanism 634 uses a linear actuator, the actuation system may include one or more solenoids mounted to ground, for example a transmission housing. Each solenoid acts on a locking element to position the locking element in a deployed or nondeployed position.

In the foregoing examples, the locking elements 30B, 38A of the power transmission or assembly 10 and the locking elements 644, 656 of the power transmission or assembly 610 have features to limit the speed at which they engage, they ratchet or have ratcheting features.

In another example, the locking elements 644, 656 of the power transmission or assembly 610 may or may not ratchet or have ratcheting features. In this example, the speed of the input or shaft 612 controls the deployment of a locking element, wherein non-ratcheting locking elements are deployed when the relative rotating components synchronize, they are rotating within a predetermined window of rotational speed. In one example, relative rotating components are synchronized when the predetermined window of rotational speed is a difference of ±100 RPM. For example, if the locking element 656 of the third controllable one-way clutch or coupling assembly 652 did not ratchet, have ratcheting features, the locking element 656 should not be deployed until the speed of relative components, the ring gear 620 and planet carrier 624, synchronize. This typically requires accurate and precise motor and speed control. Sometimes, locking element deployment is conditioned upon an overrunning condition between the speed of relative components. Wherein, the locking element is deployed in an overrun condition after which torque is then applied to wherein the locking element catches a notch in the notch plate to complete the shift. If the locking element 644 of the second controllable one-way clutch or coupling assembly 640 did not ratchet, have ratcheting features, the locking element 644 could not be deployed until the speed of relative components, the ring gear 620 and ground 632 synchronize. Because ground 632 is stationary, does not rotate, the speed 180 of the input member or first shaft 612 must be controlled relative to the speed 184 of 2^{nd} gear ratio to control and reduce the speed of the ring gear 620 until it is stationary, or nearly stationary, before deploying the locking element 644. Because the speed 184 of the 2^{nd} gear ratio may vary, controlling the input speed 180 to meet the predetermined range or window typically requires accurate and precise motor and speed control which may require additional time to complete a shift.

The power transmission system or assemblies 10, 610 may include multiple types of actuators, including linear actuators, cam actuators, selector plates, and shift fork actuators. The actuators may also be dynamically controllable actuators or controllable mechanical diode actuators with or without selector plates. The actuators may be multiple positions actuators having, for example, three, four, and five positions. In addition, sprag or roller one-way clutches may be used with dog clutches, dynamically controllable clutches, or controllable mechanical diode actuators. Further, the locking elements may extend radial or planar.

While the present examples illustrate the power transmission system or assemblies 10, 610 as layshaft and planetary gear systems, additional or alternative gear assemblies may be used. Other examples of gear assemblies include single, multiple component gear systems, and/or architectures including multiple planetary gearsets, in particular those having overdrive or reverse. Gear systems having more than two speeds or gear ratios are also contemplated, along with a combination of planetary gear sets and layshafts.

In addition, while the locking elements are shown moving in an axial direction, they may also move radially with respect to the rotational axis. The torque carrying elements, the locking elements, may be orientated as planar, radial, or a combination of both. While the present examples disclose two ratcheting locking elements, all four of the locking elements could be ratcheting locking elements. In another example, the system may only use one ratcheting locking element. The number of ratcheting locking elements may vary depending upon regeneration, reverse, and use of multiple gears, including planetary gears and layshaft gears.

The foregoing are examples showing use of ratcheting locking element are merely exemplary. They are not intended to include all of the various shift scenarios that may be achieved using the present invention, including by way of example shifting between multiple gear ratios, including bypassing a gear ratio, shift directly from 1^{st} to 3^{rd} gear. In addition, shifting between various power on and power off situations, for example, 1^{st} gear power on to 2^{nd} gear power off, is also contemplated.

As used herein, the phrase from A and from B should be construed to mean a logical A or B, using a non-exclusive logical or and should not be construed to mean at least one of A and one of B. For example, depending on the situation a torque transmitting element may transmit torque in both directions—from the first shaft to the second shaft or from the second shaft to the first shaft. It should be understood that the torque transmitting element may transmit torque in both directions; however, it does not mean the torque transmitting element transmits torque in both directions at the same time. For example, a torque transmitting element may transmit reverse torque or regeneration torque or both reverse and regeneration torque at different times based on different operating parameters.

The indefinite articles “a” and “an,” as used in the specification and in the claims should be understood to mean “at least one,” and should not be limited to “only one” unless explicitly indicated to the contrary.

As used herein the term “no” means not any, hardly any, or very little. In one example, “no torque” is an insubstantial or insignificant amount of torque that does not measurably affect desired operation and is not considered significant by a person of ordinary skill in the art.

The description of the invention is merely exemplary in nature. Thus, variations that do not depart from the gist of the invention are intended to be within the scope of the invention. Such variations are not to be regarded as a departure from the spirit and scope of the invention.

What is claimed is:

1. A power transmission system comprising:
a first shaft;
a second shaft;
a first gear assembly between the first shaft and the second shaft;
a second gear assembly between the first shaft and the second shaft;
a first coupling mechanism selectively coupling the first shaft and the second shaft through the first gear assembly, the first coupling mechanism includes a locking element; and
a second coupling mechanism selectively coupling the first shaft and the second shaft through the second gear assembly, the second coupling mechanism includes a ratcheting locking element movable between a deployed position and a nondeployed position.

2. The power transmission system of claim 1 includes:
an actuator operative to move the ratcheting locking element of the second coupling mechanism between the deployed position and the nondeployed position.

3. The power transmission system of claim 1 wherein:
the first coupling mechanism includes a ratcheting locking element movable between a deployed and a nondeployed position; and
an actuator operative to move the ratcheting locking element of the first coupling mechanism between the deployed position and the nondeployed position.

4. The power transmission system of claim 1 wherein:
the locking element of the first coupling mechanism is a passive locking element; and
the ratcheting locking element of the second coupling mechanism is a controllable locking element.

5. The power transmission system of claim 1 includes:
a torque path extending from the first shaft to the second shaft through a gearset;
the locking element of the first coupling mechanism transfers torque from the first shaft to the second shaft in the torque path; and
the ratcheting locking element of the second coupling mechanism transfers torque from the first shaft to the second shaft in the torque path.

6. The power transmission system of claim 1 wherein:
the first shaft rotates in a first direction and in a second direction;
the first coupling mechanism includes a first one-way clutch associated with the first direction of rotation, the first one-way clutch of the first coupling mechanism includes the locking element of the first coupling mechanism;
the first coupling mechanism includes a second one-way clutch associated with the second direction of rotation, the second one-way clutch of the second coupling mechanism includes a controllable ratcheting locking element;
the second coupling mechanism includes a first one-way clutch associated with the first direction of rotation, the first one-way clutch of the second coupling mechanism includes the ratcheting locking element of the second coupling mechanism;
the second coupling mechanism includes a second one-way clutch associated with the second direction of rotation; and
the second one-way clutch of the second coupling mechanism includes a controllable locking element.

7. The power transmission system of claim 6 wherein:
the locking element of the first one-way clutch of the first coupling mechanism is controllable.

8. The power transmission system of claim 6 wherein:
The locking element of the first one-way clutch of the first coupling mechanism is passive.

9. The power transmission system of claim 1 wherein:
the first coupling mechanism includes a one-way clutch associated with a first direction of rotation of the first shaft and a controllable one-way clutch associated with a second direction of rotation of the first shaft; and
the second coupling mechanism includes a first selectable one-way clutch associated with the first direction of rotation of the first shaft and a second selectable one-way clutch associated with the second direction of rotation of the first shaft.

10. The power transmission system of claim 1 wherein:
the first shaft rotates in a first direction and a second direction;
the second shaft rotates in the first direction and the second direction; and
the second shaft rotates in the direction of the first shaft.

11. A power transmission method comprising:
providing a first shaft, the first shaft rotatable at a variable rotation speed;
providing a second shaft, the second shaft rotatable at a variable rotation speed;
providing a gear assembly, the gear assembly includes at least a first gear ratio and a second gear ratio;
providing a first one-way clutch associated with the first gear ratio, the first one-way clutch associated with the first gear ratio includes a torque transmitting locking element;
providing a first one-way clutch associated with the second gear ratio, the first one-way clutch associated with the second gear ratio includes a torque transmitting locking element;
deploying the torque transmitting locking element of the first one-way clutch associated with the first gear ratio and enabling torque from the first shaft to the second shaft in the first gear ratio;
deploying the torque transmitting locking element of the first one-way clutch associated with the second gear ratio when the speed of the first shaft and the speed of the second gear ratio are not within a predetermined window of rotational speed; and
changing the rotation speed of the first shaft to place the speed of the first shaft and the speed of the second gear ratio within the predetermined window of rotational speed, wherein the torque transmitting locking element of the first one-way clutch associated with the second gear ratio engages and enables torque from the first shaft to the second shaft in the second gear ratio.

12. The power transmission method of claim 11 wherein:
the torque transmitting locking element of the first one-way clutch associated with the second gear ratio is a ratcheting locking element.

13. The power transmission method of claim 11 including:
applying torque from the second gear ratio to the first shaft through the torque transmitting locking element of the first one-way clutch associated with the second gear ratio, wherein the rotation speed of the first shaft reduces to the speed of the second gear ratio.

14. The power transmission method of claim 11 including:
transferring no torque through torque transmitting element of the first one-way clutch associated with the second gear ratio when the torque transmitting element of the first one-way clutch associated with the second gear ratio is deployed, and the speed of the first shaft and the speed of the second gear ratio are not within the predetermined window of rotational speed.

15. The power transmission method of claim 11 including:
providing a second one-way clutch associated with the first gear ratio, the second one-way clutch associated with the second gear ratio includes a torque transmitting locking element; and
deploying the torque transmitting locking element of the second one-way clutch associated with the first gear ratio and enabling torque from the second shaft to the first shaft in the first gear ratio and from the first shaft to the second shaft in the first gear ratio.

16. The power transmission method of claim 11 including:
providing a second one-way clutch associated with the second gear ratio, the second one-way clutch associated with the second gear ratio includes a torque transmitting locking element; and
deploying the torque transmitting locking element of the second one-way clutch associated with the second gear ratio and enabling torque from the second shaft to the first shaft in the second gear ratio and from the first shaft to the second shaft in the second gear ratio.

17. A power transmission method comprising:
providing a first shaft, the first shaft rotatable at a variable rotation speed;
providing a second shaft, the second shaft rotatable at a variable rotation speed;
providing a gear assembly, the gear assembly includes at least a first gear ratio and a second gear ratio;
providing a first one-way clutch associated with the first gear ratio, the first one-way clutch associated with the first gear ratio includes a torque transmitting locking element, and a second one-way clutch associated with the first gear ratio, the second one-way clutch associated with the first gear ratio includes a torque transmitting element;
providing a first one-way clutch associated with the second gear ratio, the first one-way clutch associated with the second gear ratio includes a torque transmitting locking element;
enabling torque from the first shaft to the second shaft through the second gear ratio with the torque transmitting locking element of the first one-way clutch associated with the second gear ratio in a deployed position;
deploying the torque transmitting locking element of the second one-way clutch associated with the first gear ratio before the speed of the first shaft and the speed of the first gear ratio are within a predetermined window of rotational speed;
moving the torque transmitting locking element of the second one-way clutch associated with the second gear ratio to a nondeployed position; and
after the torque transmitting locking element of the first one-way clutch associated with the second gear ratio is in a nondeployed position, changing the rotation speed of the first shaft to engage the torque transmitting locking element of the second one-way clutch associated with the first gear ratio wherein the torque transmitting element of the second one-way clutch associated with the first gear ratio transmits torque from the first gear ratio to the first shaft through the first gear ratio.

18. The power transmission method of claim 17 wherein:
the torque transmitting locking element of the second one-way clutch associated with the first gear ratio is a ratcheting locking element.

19. The power transmission method of claim 17 including:
increasing the speed of the first shaft to engage the torque transmitting element of the first one-way clutch associated with the first gear ratio to transmit torque from the first shaft to the second shaft through the first gear ratio.

20. The power transmission method of claim 17 including:
applying torque from the first gear ratio to the first shaft through the torque transmitting locking element of the second one-way clutch associated with the first gear ratio, wherein the rotation speed of the first shaft increases to the speed of the first gear ratio.

21. The power transmission method of claim 17 including:
increasing the speed of the first shaft to passively engage the torque transmitting locking element of the first one-way clutch associated with the first gear ratio and transfer torque from the first shaft to the second shaft in the first gear ratio.

22. The power transmission method of claim 17 including:
reducing the speed of the first shaft until the speed of the first shaft is below the speed of the second gear ratio to disengage the torque transmitting locking element of the first one-way clutch associated with the second gear ratio.

23. The power transmission method of claim 17 wherein:
the torque transmitting locking element of the second one-way clutch associated with the first gear ratio enables torque either from the second shaft to the first shaft in the first gear ratio and from the first shaft to the second shaft in the first gear ratio.

24. The power transmission method of claim 17 including:
providing a second one-way clutch associated with the second gear ratio, the second one-way clutch associated with the second gear ratio includes a torque transmitting locking element; and
deploying the torque transmitting locking element of the second one-way clutch associated with the second gear ratio and enabling torque from the second shaft to the first shaft in the second gear ratio and from the first shaft to the second shaft in the second gear ratio.
